(19) United States
(12) Patent Application Publication
(10) Pub. No.: US 2023/0143443 A1
(43) Pub. Date: May 11, 2023

(54) SYSTEMS AND METHODS OF FUSING COMPUTER-GENERATED PREDICTED IMAGE FRAMES WITH CAPTURED IMAGES FRAMES TO CREATE A HIGH-DYNAMIC-RANGE VIDEO HAVING A HIGH NUMBER OF FRAMES PER SECOND

(71) Applicant: META PLATFORMS TECHNOLOGIES, LLC, Menlo Park, CA (US)

(72) Inventors: Ingrid Anda Cotoros, Hillsborough, CA (US); Vikas CHANDRA, Fremont, CA (US)

(21) Appl. No.: 17/978,914

(22) Filed: Nov. 1, 2022

Related U.S. Application Data
(60) Provisional application No. 63/277,065, filed on Nov. 8, 2021.

(51) Int. Cl. G06T 5/50; G06T 5/00; H04N 5/265; G06T 11/00

(52) U.S. Cl. CPC G06T 5/50; G06T 5/009; H04N 5/265; G06T 11/00; G06T 2207/20208; G06T 2207/20221; G06T 2207/10016; G06T 2207/20081

(57) ABSTRACT

A method of using computer-generated predicted image frames to create a high-dynamic-range (HDR) video is described. A method includes receiving first and second captured image frames via an image sensor. The first captured image frame represents a scene in the real-world at a first point in time and the second captured image frame represents the scene in the real-world at a second point in time that is after the first point in time. The method further includes in accordance with a determination that the first captured image frame and the second captured image frame will be used to produce an HDR video, generating a computer-generated predicted image frame representing the scene in the real-world at a time between the first point in time and the second point in time and fusing the second image frame with the computer-generated predicted image frame to generate an HDR frame for the HDR video.

### RELATED APPLICATION

This application claims priority to U.S. Provisional Patent Application No. 63/277,065, filed Nov. 8, 2021, titled “Systems And Methods Of Fusing Computer-Generated Predicted Image Frames With Captured Images Frames To Create A High-Dynamic-Range Video Having A High Number Of Frames Per Second,” which is hereby incorporated by reference in its entirety.

### TECHNICAL FIELD

This application relates generally to the creation of high-dynamic-range (HDR) videos and more specifically to creation of HDR videos with a high number of frames per second (e.g., 32 frames per second or higher) by fusing computer-generated image frames with captured image frames to achieve the high number of frames per second.

### BACKGROUND

Conventional approaches for generating a high-dynamic-range (HDR) video use multiple captured image frames to generate a single HDR frame that becomes a part of an HDR video. Use of multiple captured image frames result in HDR videos with frame rates that are lower than the maximum number of frames per second that an image sensor can capture (e.g., the HDR video can end up with 16 frames per second while the image sensor can be capable of capturing 32 frames per second). Stated another way, conventional approaches for generating HDR videos can result in frame rates that are half the frame rates for non-HDR videos. The reduced frame rates result in lower-quality HDR videos. Additionally, in some embodiments, the maximum frame rate achievable by the conventional approaches is limited by the need to have at least two captured image frames available before each HDR output frame is created, e.g., because processing of HDR output frames must occur after at least two captured image frames are available which can hinder ability of a camera system to generate a higher number frames per second since the system must always wait for capturing of another image frame to complete.

As such, there is a need for systems and methods that can create HDR videos with higher frame rates.

### SUMMARY

The disclosed methods and systems make use of computer-generated predicted image frames to allow for creation of a high-dynamic-range (HDR) video having a high number of frames per second (fps) than is currently achievable. In particular, rather than requiring a camera or imaging system to wait for at least two image frames to be captured before creating an HDR output frame, the techniques described herein provide for quick generation of computer-generated predicted image frames, which then allows for quicker creation of HDR output frames since the system need not constantly wait for capturing of pairs of captured image frames to complete before and HDR output frame can be created. This helps make efficient use of processing resources and avoids limiting processing downtime of some existing approaches for HDR video processing. This is explained in more detail with reference to the processes/techniques described with reference to FIGS. 2-6 and enables camera systems (and devices including camera systems, such as smartphones, smart watches, smart glasses, tablets, and other devices with camera systems that are used for creating HDR videos) to produce HDR videos having the high number of frames per second. In some embodiments, the high number of fps means an fps equal to or greater than an fps that can be achieved by one or more processors (e.g., one or more processors 250; FIG. 2), such as 32 fps or higher, 64 fps or higher, etc. The disclosed systems and methods use machine-learning systems to generate one or more additional image frames (e.g., the computer-generated predicted image frames described herein) that can be fused/merged with captured image frames to increase the number of available HDR output frames that are used during the creation of an HDR video. With more available HDR output frames, the HDR videos created in accordance with the techniques described herein have a higher number of frames per second (e.g., a number of HDR output frames per second included in the HDR videos produced in accordance with the techniques described herein). The disclosed methods can be performed at an imaging system, such as a tablet; a wrist-wearable device; a security camera; a smartphone; a head-worn wearable device; a laptop, and/or any other device with an image sensor or camera system that is also used in conjunction with creation of HDR videos. In some embodiments, the disclosed methods can be performed, in part, at a computing device communicatively coupled to the imaging system, such as a server; a tablet; a smartphone; a laptop; a wrist-wearable device; a head-worn wearable device; and/or other computing device with one or more processors.

(A1) In accordance with some embodiments, a method of using computer-generated predicted image frames to create a high-dynamic-range video having a high number of frames per second is provided. The method includes receiving, at one or more processors that are in communication with an image sensor configured to capture image frames used to produce an HDR video, a first captured image frame and a second captured image frame captured via the image sensor. The first captured image frame represents a scene in the real-world at a first point in time and the second captured image frame represents the scene in the real-world at a second point in time that is after the first point in time (the first and second points in time can represent respective points in time at which exposures used to capture with the first and second captured image frames end). The method further includes, in accordance with a determination that the first captured image frame and the second captured image frame will be used to produce an HDR video, generating, via the one or more processors and based on the first captured image frame, a computer-generated predicted image frame representing the scene in the real-world at a time between the first point in time and the second point in time. The method also includes fusing (or merging) the second captured image frame with the computer-generated predicted image frame to generate an HDR frame (also referred to herein as an HDR output frame, as a fused HDR frame, or simply as a fused frame, all of which interchangeably refer to the frame produced after fusing or merging the second image frame with the computer-generated predicted image frame) for the HDR video.

(A2) In some embodiments of A1, the method further includes repeating the receiving, generating, and fusing operations to produce respective HDR frames for the HDR video, such that the HDR video has at least 32 frames per second. Stated another way, additional captured image frames are received at the receiving operation, additional computer-generated predicted image frames are then generated for respective points in time that are between respective points in time for two captured image frames, and then additional HDR output frames are created through fusing operations between capturing and computer-generated image frames until at least 32 HDR output frames are produced per second. More specifically, at the receiving operation, a third captured image frame (representing the scene in the real-world at a third time that is after the first and second points in time) can be received from the image sensor; at the generating operation, a second computer-generated predicted image frame representing the scene in the real-world at a time between the second point in time and the third point in time is created; and, at the fusing operation, the third captured image frame can be fused/ merged with the second computer-generated predicted image frame to generate a second HDR frame for the HDR video. And this repeats for fourth, fifth, sixth, etc. captured image frames at the receiving operation, repeats for third, fourth, fifth, etc. computer-generated image frames at the generating operation, and repeats for fusing each respective pair of captured image frame with a computer-generated predicted image frame such that an HDR video with a high number of frames per second is produced.

(A3) In some embodiments of A1-A2, the HDR video includes: (i) a first HDR frame that was created by fusing two captured image frames, and (ii) a second HDR frame that was created by fusing two computer-generated predicted image frames. In other words, in addition to fusing captured image frames with computer-generated predicted image frames, fusing can also occur for two captured image frames and/or for two computer-generated predicted image frames.

(A4) In some embodiments of A1-A3, the method further includes after producing the HDR video, receiving captured image frames captured via the image sensor and producing a non-HDR video without generating or using any computer-generated predicted image frames. The HDR video has a first number of frames that is greater than or equal to a second number of frames for the non-HDR video. In other words, the image sensor (and a device associated therewith) can be configured to capture both HDR and non-HDR videos, but only the HDR video processing generates and makes use of computer-generated predicted image frames.

(A5) In some embodiments of A4, the first number of frames per second and the second number of frames per second is 32 frames.

(A6) In some embodiments of A1-A5, the computer-generated predicted image frame is generated while the second captured image frame is being captured by the image sensor. As compared to some techniques for producing HDR videos, being able to generate the computer-generated predicted image frame while the second captured image frame is being captured by the image sensor allows for producing more HDR output frames per second, as the system need not wait for capturing of pairs of captured image frames to be available before producing the next HDR output frame. Instead, the system, by applying the techniques described herein is able to quickly generate the computer-generated predicted image frame and fuse that predicted image frame with the second captured image frame, and can therefore repurpose processing time previously lost while waiting for the second captured image frame to be captured along with a next third captured image frame that would have been fused with the second captured image frame to produce an HDR output frame. Stated simply, processing time lost during capturing of the second and third captured image frames can be repurposed to generate a computer-generated predicted image frame for fusing with the second captured image frame, thereby producing more HDR output frames per second by avoiding the processing downtime of some existing approaches for HDR video processing.

(A7) In some embodiments of A1-A6, the one or more processors that are in communication with the image sensor receive a third captured image frame representing the scene in the real-world at a third point in time that is after the second point in time, and the third captured image frame is captured, in part, while the HDR frame is being generated. Again, in some embodiments, this helps to ensure that more HDR output frames can be produced per second as capturing of image frames can continue while HDR output frames are being created.

(A8) In some embodiments of A1-A7, the computer-generated predicted image frame is a first computer-generated predicted image frame and the HDR frame is a first HDR frame, and the method further includes receiving, at the one or more processors that are in communication with the image sensor, a third captured image frame captured via the image sensor. The third captured image frame represents the scene in the real-world at a third point in time that is after the second point in time (as with the first and second points in time, the third point in time can represent a point in time at which an exposure used to capture with the third captured image frame ends). In accordance with a determination that the third captured image frame will be used in conjunction with the first captured image frame and the second captured image frame to produce the HDR video, the method includes generating, via the one or more processors and based on the second captured image frame, a second computer-generated predicted image frame representing the scene in the real-world at the time between the second point in time and the third point in time and fusing the third image frame with the second computer-generated predicted image frame to generate a second HDR frame for the HDR video. This is another more specific example of the looping behavior described above with reference to A2, in which various operations are repeated to allow for creation of all the HDR frames for the HDR video.

(A9) In some embodiments of A1, the method further includes receiving, at the one or more processors that are in communication with the image sensor, a third captured image frame captured via the image sensor, the third captured image frame representing the scene in the real-world at a third point in time that is after the second point in time (as with the first and second points in time, the third point in time can represent a point in time at which an exposure used to capture with the third captured image frame ends). In accordance with a determination that the third captured image frame will be used in conjunction with the first captured image frame and the second captured image frame to produce the HDR video, the method includes generating, via the one or more processors and based on the first captured image frame and the third captured image frame, the computer-generated predicted image frame representing the scene in the real-world at the time between the first point in time and the second point in time and fusing the computer-generated predicted image frame with the second image frame and the computer-generated predicted image frame to generate the HDR frame for the HDR video.

(A10) In some embodiments of A9, the computer-generated predicted image frame is a first computer-generated predicted image frame and the HDR frame is a first HDR frame, and the method further includes receiving, at the one or more processors that are in communication with the image sensor, a fourth captured image frame captured via the image sensor. The fourth captured image frame represents the scene in the real-world at a fourth point in time that is after the third point in time. In accordance with a determination that the fourth captured image frame will be used in conjunction with the first captured image frame, the second captured image frame, and the third captured image frame to produce the HDR video, the method includes generating, via the one or more processors and based on the second captured image frame and the fourth captured image frame, a second computer-generated predicted image frame representing the scene in the real-world at the time between the third point in time and the second point in time and fusing the third image frame with the second computer-generated predicted image frame to generate a second HDR frame for the HDR video.

(A11) In some embodiments of A1-A10, the first captured image frame is a first type of image frame, the second captured image frame is a second type of image frame, and the first type of image frame is distinct from the second type of image frame.

(A12) In some embodiments of A11, the first type of image frame has a short exposure duration, and the second type of image frame has a long exposure duration that is greater than the short exposure duration.

(A13) In some embodiments of A1-A12, the computer-generated predicted image frame is generated via a machine-learning system that has been trained using a training set consisting of a variety of image frames captured by an image sensor viewing different scenes in the real world.

(A14) In some embodiments of A1-A13, the HDR video has a number of frames per second (fps) that is at least equal to a maximum fps achievable by the one or more processors when using captured image frames to produce a video.

(A15) In some embodiments of A14, the HDR video has a fps greater than a maximum fps achievable by the one or more processors when using captured image frames to produce a video.

(A16) In some embodiments of A1-A15, the image sensor is part of a security camera, smartphone, smart watch, tablet, or AR glasses. As non-limiting examples, the image sensor can be a component of a imaging system 204 for a security camera (e.g., example depicted in FIG. 2) or the image sensor can be a component of the wrist-wearable device 800 shown in FIG. 8.

(B1) In another aspect, a system for generating an HDR video is provided. The system includes an image sensor configured to capture image frames used to produce a high-dynamic range (HDR) video and one or more processors that are in communication with the image sensor. The one or more processors are configured to receive a first captured image frame and a second captured image frame captured via the image sensor. The first captured image frame represents a scene in the real-world at a first point in time and the second captured image frame represents the scene in the real-world at a second point in time that is after the first point in time. The one or more processors, in accordance with a determination that the first captured image frame and the second captured image frame will be used to produce an HDR video, generate, via the one or more processors and based on the first captured image frame, a computer-generated predicted image frame representing the scene in the real-world at a time between the first point in time and the second point in time and fuse the second image frame with the computer-generated predicted image frame to generate an HDR frame for the HDR video. Non-limiting examples of the system include any one of a security camera, smartphone, smart watch, tablet, or AR glasses.

(B2) In some embodiments of B1, the one or more processors are further configured to perform the method of any of claims A2-A15.

(C1) In one other aspect, a non-transitory computer-readable storage medium including instructions for generating an HDR video is provided. The instructions for generating an HDR video, when executed by a device (e.g., non-limiting examples of the device include any one of a security camera, smartphone, smart watch, tablet, or AR glasses) that includes an image sensor, cause the device to perform the method of any of claims A2-A16.

(D1) In yet a further aspect, a device including an image sensor is provided. Non-limiting examples of the device include any one of a security camera, smartphone, smart watch, tablet, or AR glasses. The device including the image sensor is configured to perform the method of any of claims A2-A15.

(E1) In another aspect, means for performing the method any of A1-A15 are provided. The means can include software algorithms (e.g., algorithms implementing the flowcharts that are described below) performed on general-purpose hardware or application-specific integrated circuits (or a combination of both) configured to perform the algorithms described herein (e.g., algorithms implementing the flowcharts that are described below). The general-purpose hardware and/or application-specific integrated circuits can be integrated with a device, such as a security camera, smartphone, smart watch, tablet, or AR glasses.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not necessarily have been selected to delineate or circumscribe the subject matter described herein.

### BRIEF DESCRIPTION OF THE DRAWINGS

So that the present disclosure can be understood in greater detail, a more particular description may be had by reference to the features of various embodiments, some of which are illustrated in the appended drawings. The appended drawings illustrate pertinent example features of the present disclosure and are therefore not to be considered limiting, for the description may admit to other effective features as the person of skill in this art will appreciate upon reading this disclosure.

FIG. 1A illustrates one technique for creating an HDR video.

FIG. 1B illustrates a timeline of image frames captured by a camera system, as well as the processing of only captured image frames during video processing in accordance with the one technique of FIG. 1A for creating an HDR video.

FIG. 2 illustrates a camera system that is configured to both capture image frames and predict image frames during video processing, in accordance with some embodiments.

FIG. 3A illustrates a process for creating computer-generated predicted image frames by using an inference-processing technique on one or more captured image frames, and then creating fused image frames based on the computer-generated predicted image frames and captured image frames, in accordance with some embodiments.

FIG. 3B shows a timeline that illustrates HDR video processing that involves capturing image frames, generating computer-generated predicted image frames using the inference-processing technique, and then creating HDR output frames, in accordance with some embodiments.

FIG. 4A illustrates a process for creating computer-generated predicted image frames by using an interpolation-processing technique on one or more captured image frames, and then creating fused image frames based on the computer-generated predicted image frames and captured image frames, in accordance with some embodiments.

FIG. 4B shows a timeline that illustrates HDR video processing that involves capturing image frames, generating computer-generated predicted image frames using the interpolation-processing technique, and then creating HDR output frames, in accordance with some embodiments.

FIG. 5 is a flow diagram showing a process for HDR video processing that makes use of either or both of the inference-processing and interpolation-processing techniques in conjunction with creation of an HDR video, in accordance with some embodiments.

FIG. 6 illustrates a method of using computer-generated predicted image frames to create an HDR video having a high number of frames per second (fps), in accordance with some embodiments.

FIGS. 7A and 7B illustrate one non-limiting example of a device (e.g., a wrist-wearable device 750) that can be used in conjunction with the video-processing techniques described herein, in accordance with some embodiments.

FIG. 8 is one non-limiting block diagram of a device (e.g., a wrist-wearable device system 800) that can be used in conjunction with the video-processing techniques described herein, according to at least one embodiment of the present disclosure.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein in order to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not been described in exhaustive detail so as to avoid obscuring pertinent aspects of the embodiments described herein.

As will become apparent to a person of skill in this art upon reading this disclosure, the various embodiments provide systems and methods of using computer-generated predicted image frames to enable the generation of a high-dynamic-range (HDR) video having a high number of frames per second (fps).

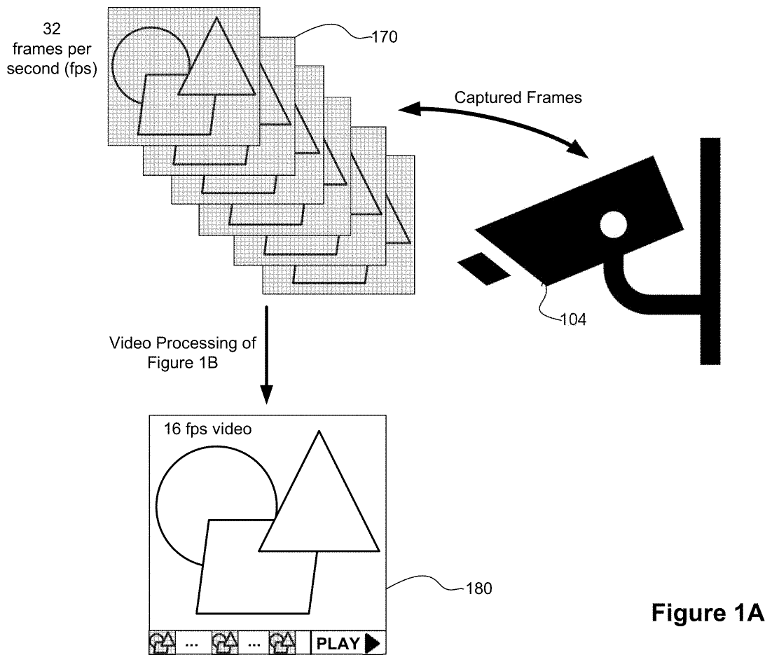

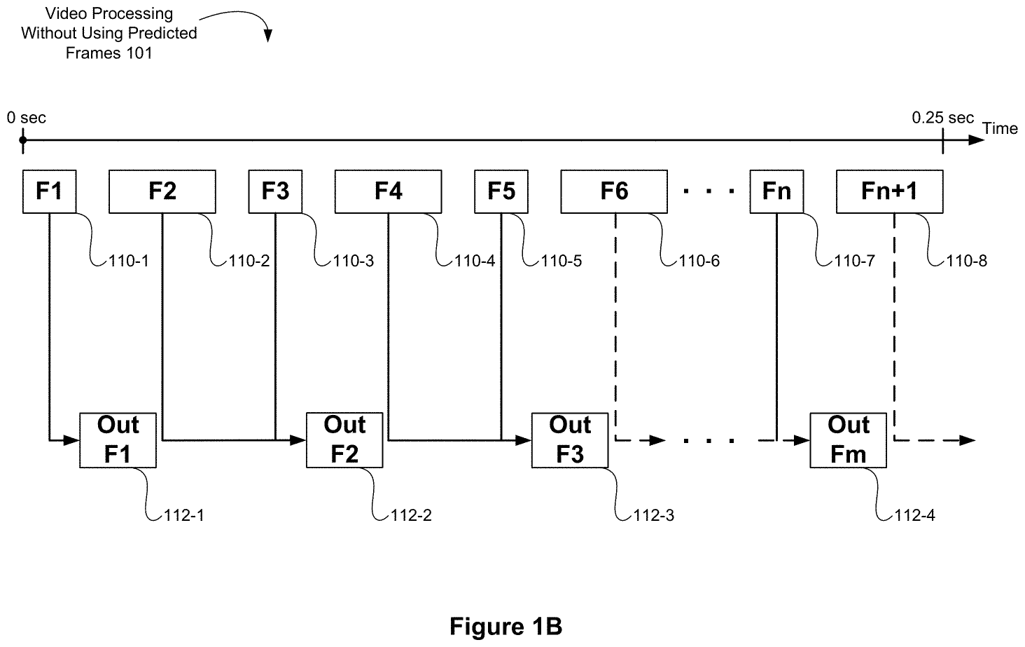

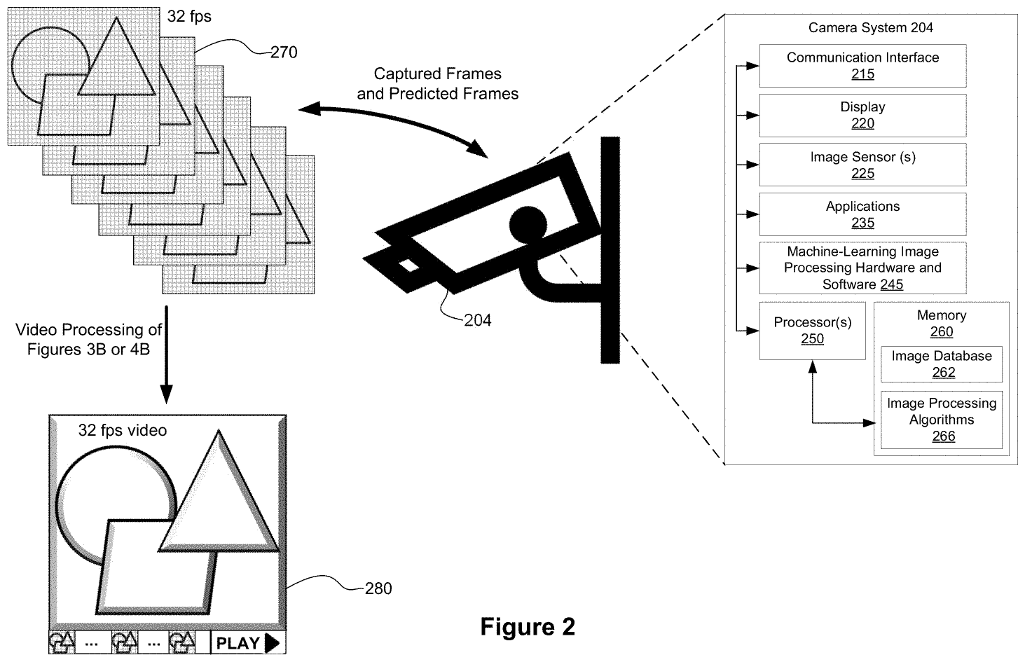

FIG. 1A illustrates one technique for creating an HDR video. The camera system 104 of FIG. 1A can include an HDR mode configured to capture successive image frames 170 with alternating exposure lengths at a predetermined frame rate (e.g., 32 frames per second (fps)). Image frames have different exposures based on the amount of light that reaches imaging components (e.g., image sensor 225; FIG. 2) of the camera system 104 (or an imaging system 204; FIG. 2) when an image frame is captured. The exposure, or amount of light that reaches the image sensor 225 when capturing an image frame, is increased or decreased based on adjustments to an image sensor 225's sensitivity, aperture, shutter speed, and/or a number of other techniques. In some embodiments, the exposure is automatically selected by the image sensor 225 (e.g., when the image sensor 225 is in an HDR mode it will capture image frames with different predetermined exposures). For simplicity, the descriptions herein focus on short and long exposures as illustrative examples, in which short exposures refer to an amount of light reaching the image sensor 225 over a first predetermined exposure length and long exposures refer to an amount of light reaching the image sensor 225 over a second exposure length that is longer than the first predetermined exposure length (e.g., the second predetermined exposure length can be twice as long as the first predetermined exposure length). Beyond this exposure-length difference, other exposure differences are contemplated and will be recognized by one of skill in the art upon reading this disclosure (e.g., two different shutter speeds in addition to, or as alternatives to, the use of two different predetermined exposure lengths).

An HDR video can be created after combining multiple image frames with different exposures taken close together in time to result in a dynamic range higher than those of individually-captured image frames. For example, referring again to FIG. 1A, image frames 170 can include twenty or more individual exposures that are combined into the HDR video 180. As shown in FIG. 1B, the image frames 170 captured by the camera system 104 can include at least a first captured image frame 110-1 with a first exposure length; a second captured image frame 110-2, following the first image frame 110-1, with a second exposure length; and a third image frame 110-3, following the second image frame 110-2, with the first exposure length.

In the approach shown in FIG. 1B, the image frames 170 are processed to create the HDR video 180 of FIG. 1A (which, as shown in FIG. 1A, can include a play bar at bottom of HDR video 180, while the individual captured image frames 170 are still images and thus would not include a play bar). In particular, as shown and described below in reference to FIG. 1B, this approach combines pairs of image frames 170 to generate each HDR output frame of the HDR video 180. As a result of the processing performed by this approach, the created HDR video 180 has half the frame rate of a predetermined frame rate with which the image frames 170 were captured by the camera system 104 (e.g., 16 fps instead of the original 32 fps). In some cases, the maximum frame rate achievable using the technique of FIGS. 1A-1B is half of the frame rate that can be achieved by an image signal processor, system-on-a-chip (SoC), central processing unit (CPU), or other processors that are coupled to the camera system 104. The decreased frame rate in HDR videos 180 generated by the approach of FIGS. 1A-1B leads to a decrease in overall video quality, which results in sub-optimal viewer experiences (including users perceiving motion artifacts in HDR videos, which degrades user enjoyment of such videos).

FIG. 1B illustrates video processing without using predicted frames 101 and, in particular, shows a sample timeline of processing operations during the video processing without using predicted frames 101, including image frames captured by a camera system, as well as the processing of only captured image frames during video processing in accordance with the one technique of FIG. 1A for creating an HDR video. In particular, FIG. 1B shows the capture of successive image frames (110-1 through 110-8) over the span of 0.25 seconds. Each pair of captured image frames is processed to generate one or more HDR frames (112-1 through 112-4). Captured image frames 170 captured by the camera system 104 have alternating exposures (e.g., between short exposure and long exposure captures), such that each adjacent pair of captured image frames includes a short exposure frame that is adjacent to a long exposure frame (adjacent in time, such that the short and long captured image frames of a pair are located next to one another along the timeline of FIG. 1B, e.g., 110-2 and 110-3 form one pair). For example, image frames 110-1, 110-3, 110-5, 110-7 are all captured with short exposures and image frames 110-2, 110-4, 110-6 and 110-8 are all captured with long exposures, each short exposure frame being followed by a long exposure frame.

The adjacent pairs of captured image frames are used by the approach of FIG. 1B to create an HDR video 180. The approach of FIG. 1B, with the exception of the first image frame 110-1 (which is utilized as the first HDR frame 112-1), combines each successive pair of image frames 170 to generate the one or more HDR frames 112-2 through 112-4. For example, image frames 110-2 and 110-3 are combined (also referred to herein as fusing or merging) to generate a second HDR frame 112-2, image frames 110-4 and 110-5 are combined to generate a third HDR frame 112-3, and image frames 110-7 and 110-8 are combined to generate a fourth HDR frame 112-4. Alternatively, in some embodiments, the first image frame 110-1 is combined with the next subsequent image frame (e.g., second image frame 110-2) to generate an HDR frame. Although a total of N frames is captured by the camera system 104 in 0.5 seconds (as reflected by captured frames 110-1 through 110-8), and because the approach of FIG. 1B requires waiting on the capture of two new image frames 110 before each HDR output frame 112 is produced, only N/2 (half of N) HDR frames 112-1 through 112-4 can be produced. Thus, for image sensors capable of capturing 32 frames per second, the use of the approach of FIG. 1B would result in an HDR video with only 16 frames per second.

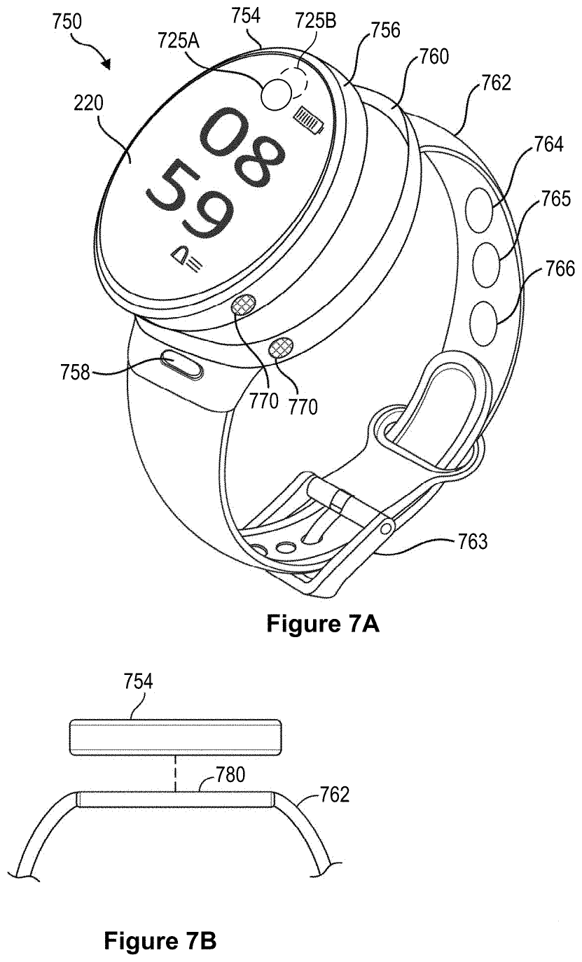

Unlike the approach of FIG. 1B, the novel techniques described herein allow for capturing of N image frames while also creating HDR videos having at least N HDR output frames (i.e., fused HDR output frames or simply fused frame). This is depicted at a high level in FIG. 2, which illustrates an imaging system that is configured to capture image frames and computer-generated predicted image frames during video processing, in accordance with some embodiments. In some embodiments, the imaging system 204 is a security camera, smartphone, smart watch (e.g., a wrist-wearable device 750 described in FIGS. 7A and 7B), tablet, a head-worn wearable device (e.g., artificial, or augmented reality headset or glasses), or other device with an image sensor 225. In some embodiments, the imaging system 204 includes one or more components such as a communication interface 215, a display 220, one or more image sensors 225 (which can be a component of the imaging system 204 that also includes a lens, aperture, and image signal processor, among other components), one or more applications 235, a machine-learning image processing hardware and software 245, one or more processors 250, memory 260. In some embodiments, the memory 260 is configured to store an image database 262 and one or more image processing algorithms 266. While these one or more components are shown in FIG. 2 as components of the imaging system 204, one of skill in the art upon reading this disclosure will appreciate that many of these one or more components can be separate from, but still communicatively coupled with, the imaging system 204 (e.g., one or more of the display 220, applications 235, machine-learning image processing hardware and software 245, processor(s) 250, and memory 260 can be communicatively coupled with the imaging system 204, such as when the imaging system 204 and these components are parts of a device like a smartphone or smart watch that includes the imaging system 204).

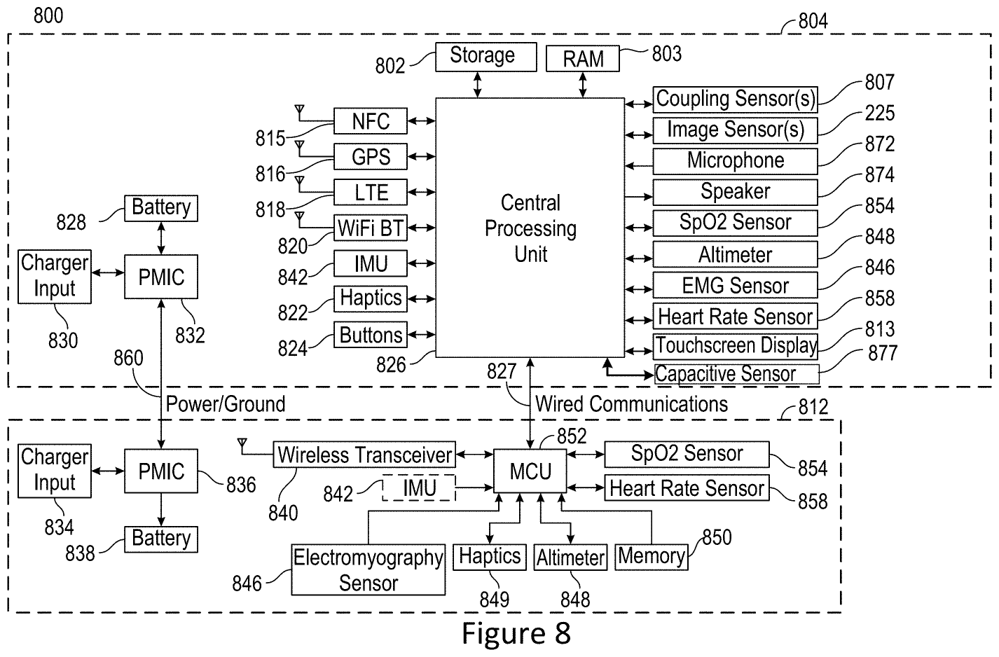

In some embodiments, the communications interface 215 is configured to communicatively couple the imaging system 204 to one or more computing devices, such as a phone, a tablet, a computer, a server, a wrist-wearable device 750, a head-worn wearable device, etc. The communication interface 215 is used to establish wired or wireless connections between the imaging system 204 and the one or more computing devices. In some embodiments, the communication interface 215 includes hardware capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol. Additional information on wired and wireless communication is provided below in reference to FIGS. 7A-8.

In some embodiments, the display 220 of imaging system 204 is configured to present information to a user, such as one or more user interfaces, images, and video. In some embodiments, the display 220 is a touch display configured to receive one or more inputs from the user. Additional information on the display 220 is provided below in reference to FIGS. 7A-8.

In some embodiments, the one or more image sensors 225 are components of an ultra-wide camera (e.g., imaging system 204), wide camera, telephoto camera, depth-sensing cameras, or other types of cameras. For example, the image sensors 225 can include a charge-coupled device (CCD) or a complementary metal oxide semiconductor (CMOS). In some embodiments, the one or more image sensors 225 (in conjunction with a lens and aperture of the camera) are used to capture still image data for photographs and captured image data for use in creating videos via the imaging system 204, which captured image data can then be processed by one or more image signal processors (e.g., one of the processor(s) 250 can be an image signal processor) of the imaging system 204 to generate images and/or video that is then presented to a user for viewing. As explained in more detail below, inference or interpolation HDR processing of the captured image data ensures that a created HDR video has a number of frames per second (also reference simply herein as “fps”) equal to at least the original fps achieved while the captured image data was captured (such that the quality of an HDR video is not degraded during processing). The imaging system 204 can include multiple different modes for capturing image data or and multiple different modes for video data. For example, these modes can include an HDR image capture mode, a low light image capture mode, burst image capture mode, a panoramic capture mode, and other modes.

In some embodiments, a particular mode is automatically selected based on environmental conditions (e.g., lighting, movement of the device, etc.) when image data is being captured. For example, an imaging system 204 with available modes for HDR image capture mode and a low light image capture mode can automatically select the appropriate mode based on the environmental conditions (e.g., dark lighting may result in the use of low light image capture mode instead of HDR image capture mode). In some embodiments, a user selects the mode that they desire to use (e.g., the user selects a toggle to cause the imaging system 204 to produce HDR videos, even if environmental conditions might have suggested use of a different mode). The image data and/or video data captured by the one or more image sensors 225 is stored in memory 260 (which can include volatile and non-volatile memory such that the image data and/or video data can be temporarily or permanently stored, as needed depending on the circumstances).

In some embodiments, the one or more applications 235 include social-media applications, banking applications, messaging applications, web browsers, imaging applications, etc., which applications can be used to permit users to share captured images and processed HDR videos with other users using the one or more applications 235. User interfaces associated with the one or more applications can be displayed on imaging system 204.

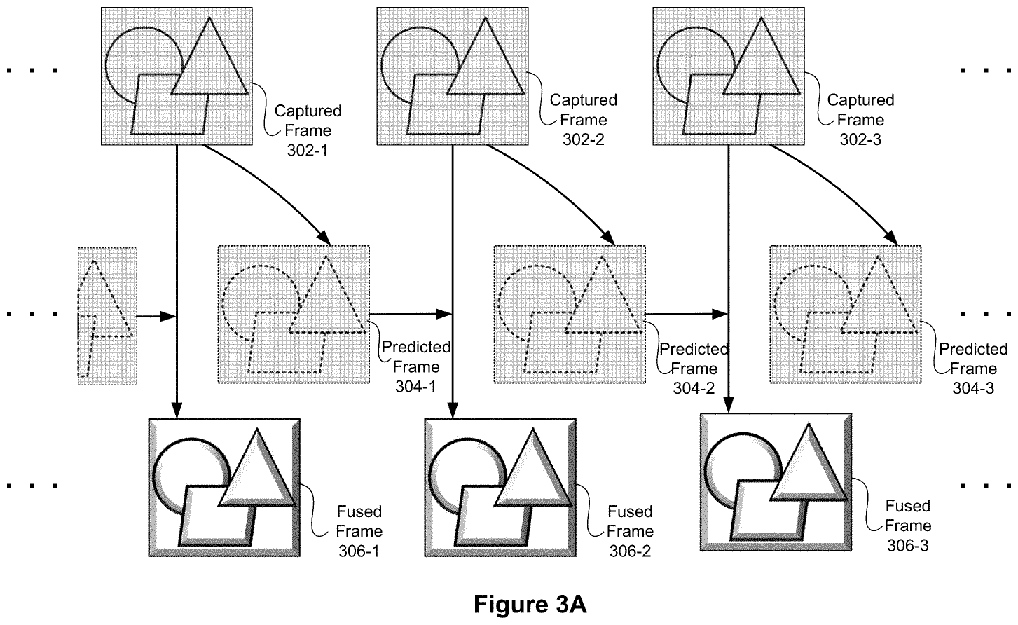

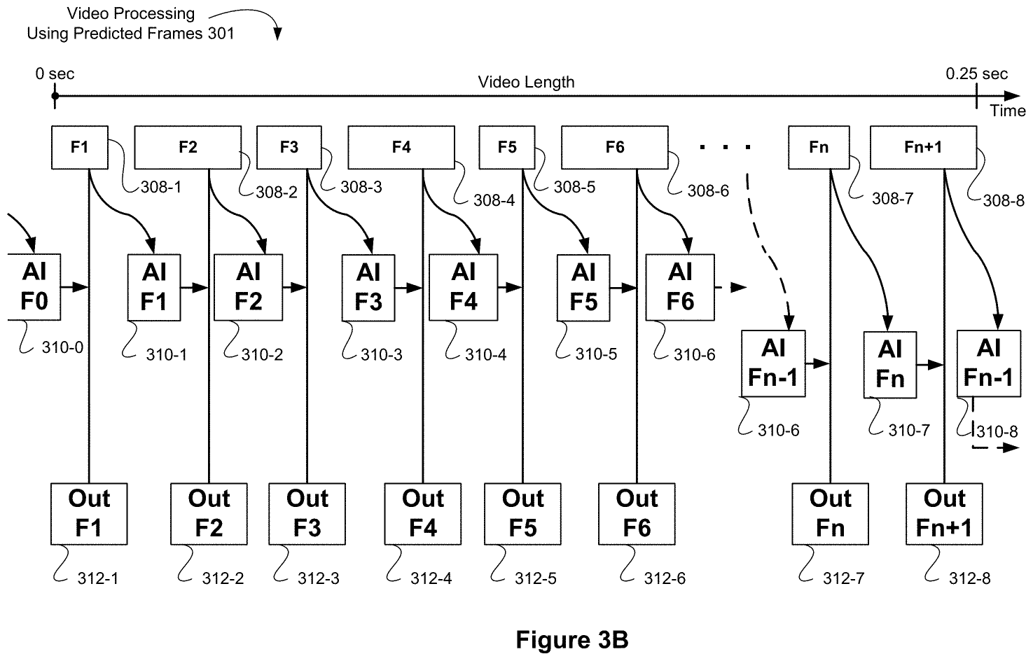

In some embodiments, the machine-learning image processing hardware and software 245 is configured to apply one or more algorithms to at least a subset of the one or more images frames 270 captured or obtained by the imaging system 204. As its name implies, the machine-learning image processing hardware and software 245 can include a combination of hardware and software that is used in conjunction with applying the machine-learning image processing techniques described herein (e.g., computer generating predicting image frames using the inference or interpolation processes described in more detail below). For example, the machine-learning image processing hardware and software 245 can apply one or more algorithms (including making use of the inference and interpolation techniques described herein to create computer-generated predicted image frames that are then fused with other image frames (predicted or captured) to create fused HDR output frames, as described below in reference to FIGS. 3A-3B (inference-related examples) and 4A-4B (interpolation-related examples)) to create the resulting HDR video 280. The HDR video 280 produced by the machine-learning image processing hardware and software 245 in configured to have an fps equal to or greater than an fps with which the captured image frames 270 were captured. The machine-learning image processing hardware and software 245 applies one or more algorithms obtained from memory 260 (e.g., from the image processing algorithms 266, which can store the appropriate algorithmic operations in software code for implementing the inference and interpolation processes for computer generating predicted image frames) and selects an appropriate algorithm for execution based on the circumstances.

The one or more processors 250 can include and/or be implemented as any kind of computing device, such as an integrated SoC, a CPU, microcontroller, a field programmable gate array (FPGA), a microprocessor, a graphics processing unit (GPU), image signal processor (ISP), digital signal processor (DSP), neural processing unit (NPU), and/or other application specific integrated circuits (ASICs). The one or more processors 250 may operate in conjunction with memory 260, e.g., to access instruction sets to assist in the performance of the techniques and processes described herein. The memory 260 may be or include random-access memory (RAM), read-only memory (ROM), dynamic random-access memory (DRAM), static random-access memory (SRAM) and magneto resistive random-access memory (MRAM), and may include firmware, such as static data or fixed instructions, basic input/output system (BIOS), system functions, configuration data, and other routines used during the operation of the imaging system 204 and the one or more processors 250. The memory 260 also provides a storage area for data and instructions associated with applications and data handled by the one or more processors 250.

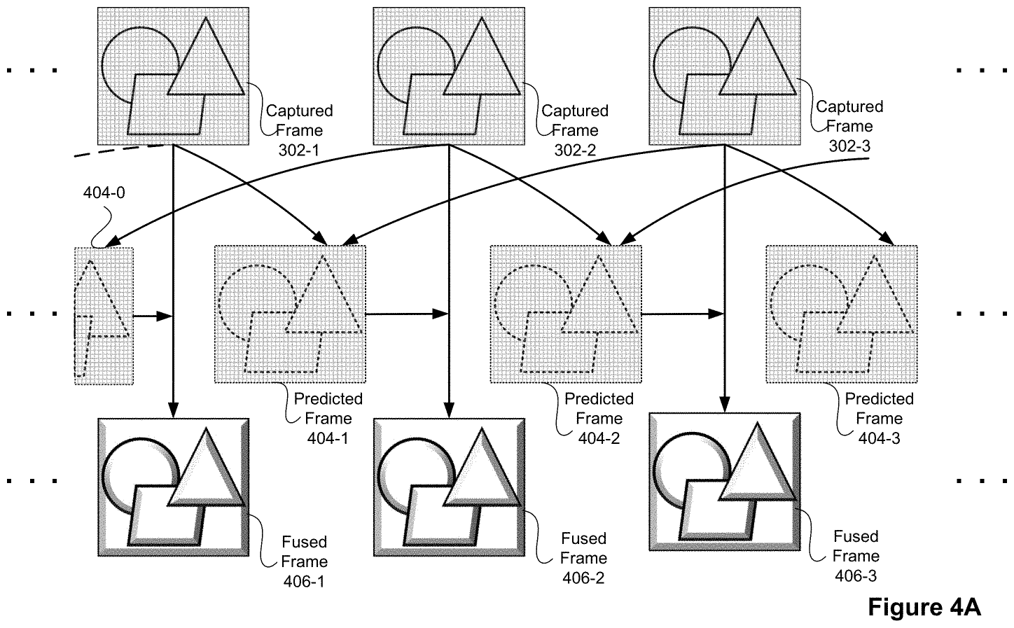

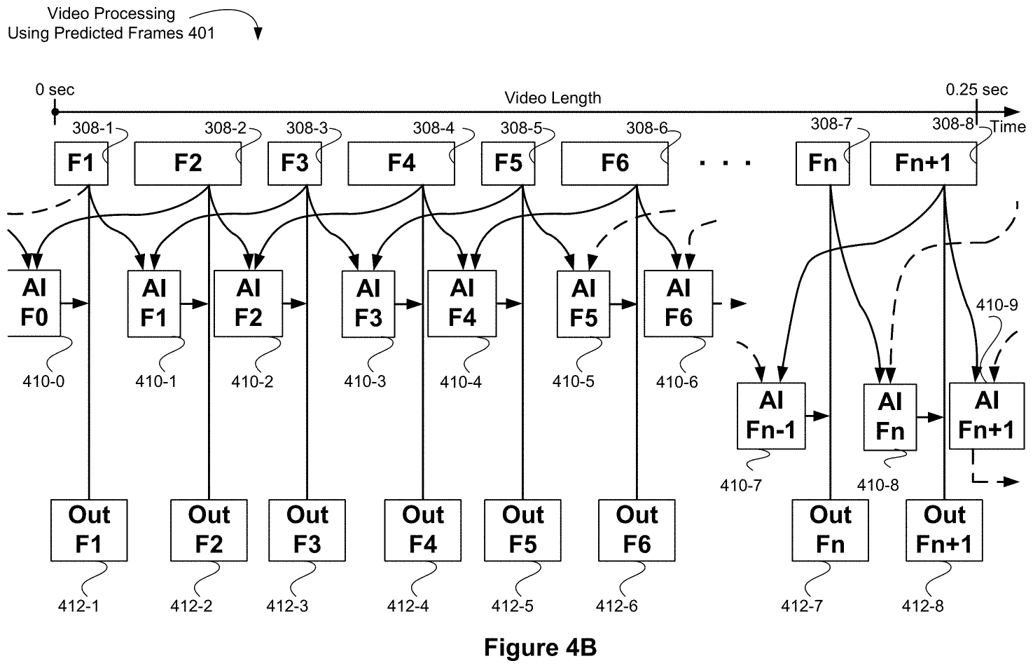

In some embodiments, the memory 260 stores at least an image database 262 (including the example captured image frames 270 (FIG. 2) captured by the one or more image sensors 225 or obtained from the one or more applications 235, as well as modified or produced image data, such as the HDR output/fused frames described herein) and image-processing algorithms 266 (which are used in conjunction with the machine-learning image processing hardware and software 245 to process the captured image data, e.g., to computer generate predicted image frames). A non-exhaustive list of image-processing algorithms include HDR video-processing algorithms, light detection and ranging (LiDAR) algorithms, night mode processing (or, more generally, low-light-condition image processing), pixel correction algorithm, a lens shading correction algorithm, a white balance correction algorithm, a denoise algorithm, a sharpening algorithm, geotagging, and other image-processing algorithms. In some embodiments, the HDR video-processing algorithms include techniques used to computer generate predicted image frames to increase frame rates in resulting HDR videos, such as an inference-processing technique used to computer-generated predicted image frames (described below in reference to FIGS. 3A and 3B) and an interpolation-processing technique used to computer generate predicted image frames (described below in reference to FIGS. 4A and 4B).

In FIG. 2, the imaging system 204 is configured to capture successive image frames 270 (e.g., successive captured frames 302-1, 302-2, and 302-3, etc., as shown in FIG. 3A). In some embodiments, the successive image frames 270 have the same or different exposure rates. In some embodiments, the successive image frames 270 have alternating exposure lengths as was described above in reference to FIGS. 1A and 1B. In some embodiments, the image frames 270 are captured at a predetermined frame rate (e.g., 32 fps, 64 fps, 90 fps, 128 fps, etc.). In some embodiments, the predetermined frame rate is based on capabilities of the one or more processors 250 (e.g., capabilities of an image signal processor of the one or more processors 25) of the imaging system 204. For example, the imaging system 204 can have an image signal processor or a SoC that is able to process captured image data at a maximum predetermined fps (e.g., 32 fps, 64 fps, 128 fps, etc.). While the primary examples described herein relate to capturing of image frames, predicting image frames, fusing frames to create HDR output frames to produce an HDR video in real-time (e.g., as the processing timelines of FIGS. 3B and 4B show, as the image frames are being captured, the system is also predicting image frames, fusing frames together and producing the HDR video in real-time as new images are being captured), the techniques described herein can also be used to improve frame rates for existing HDR videos that might have been produced in accordance with the technique of FIGS. 1A-1B (e.g., an existing HDR video can be further optimized to have a higher frame rate by applying the techniques described herein to predict additional image frames to allow for producing new version of the existing HDR videos that will then have higher frame rates). Thus, the techniques described herein can be applied both in real-time and as a form of retrofit to optimize existing HDR videos to have improved frame rates.

The imaging system 204 is configured to create the HDR video 280 based on the captured image frames 270 and computer-generated predicted image frames (e.g., predicted frames 310, FIG. 3B). In particular, the imaging system 204 utilizes the machine-learning image processing hardware and software 245 to create the HDR video 280 through a process of fusing computer-generated predicted image frames with captured image frames to create fused

HDR output frames that are used in the HDR video 280. The HDR video 280 created using the machine-learning image processing hardware and software 245 is configured to have an fps equal to or greater than the predetermined fps of the image frames 270. The HDR video 280 created using the machine-learning image processing hardware and software 245 can have at least twice the fps as compared to fps for an HDR video created using the approach shown and described above in reference to FIGS. 1A and 1B. For example, while the approaches of both FIG. 1A and FIG. 2 can make use of an image signal processor capable of capturing at 32 fps, the HDR video 180 created using the approach of FIG. 1B is limited to at most 16 fps while the HDR video 280 created using the improved techniques described herein (e.g., the inference-processing technique and/or the interpolation-processing technique) is greater than 16 fps (e.g., 24 fps, 32 fps or higher). In other words, the HDR video 280 created using the improved method has a frame rate equal to or greater than rate at which the captured image frames 270 are captured by the camera system. By producing HDR video 280 with a high number of frames, HDR video quality is improved (including reducing any motion artifacts that might be perceived by a user while viewing an HDR video with a frame rate of 16 fps or lower), thereby improving user satisfaction and enjoyment of HDR videos.

Moving on from the high-level illustration of FIG. 2, FIGS. 3A-3B provide more details concerning the use of improved HDR video-processing techniques, in particular FIG. 3A illustrates an ongoing process for creating computer-generated predicted image frames by using an inference-processing technique on one or more captured image frames, and then creating fused image frames based on the computer-generated predicted image frames and captured image frames, in accordance with some embodiments. The inference-processing technique is used by an imaging system 204 (FIG. 2) and/or other device communicatively coupled to the imaging system 204 (e.g., a server, a laptop, smartphone, smart watch, a tablet, etc.) to process one or more captured image frames 302 (e.g., first, second, and third captured image frames 302-1, 302-2 and 302-3) captured by the imaging system 204 (as was explained earlier, the primary examples provided here for illustrative purposes relate to video processing that occurs in real-time as images are captured, but the techniques described herein can also be used to improve frame rates for existing HDR videos, such that the captured image frames could have been captured by an imaging system other than the imaging system 204, such as an imaging system of another user's device that was used to create an HDR video that is then sent to another user, e.g., a user of the device that includes the imaging system 204). Specifically, the one or more captured image frames 302 are used, in conjunction with the inference-processing technique, to generate one or more respective computer-generated predicted image frames (e.g., first, second, and third computer-generated predicted image frames 304-1, 304-2, and 304-3), which are fused with the one or more captured image frames 302 to create one or more fused HDR output frames (e.g., first, second, and third fused HDR output frames 306-1, 306-2, and 306-3) for the HDR video as described in detail below. As is depicted in FIG. 3A, systems and devices making use of the inference-processing technique are capable of predicting an image frame before a next captured frame is available (e.g., predicted frame 304-1 can be made available before completion of capturing captured frame 302-2). In so doing, some embodiments are capable of producing more fused HDR output frames 306, such that a number of fused frames 306 can be equal to (and can even exceed) a number of captured frames in a given period of time (e.g., every quarter second), which allows for producing an HDR video having a high number of fps (equaling or exceeding a number of frames per second at which captured images were captured).

The first, second, and third captured image frames 302-1, 302-2 and 302-3 are representations of a scene in the real-world at a respective point in time. For example, the first captured image frame 302-1 represents a scene in the real-world at a first point in time, the second captured image frame 302-2 represents a scene in the real-world at a second point in time, and the third captured image frame 302-3 represents a scene in the real-world at a third point in time. In some embodiments, the first point in time is followed by the second point in time and the second point in time is followed by the third point in time. As described above in reference to FIG. 2, the one or more image frames 302 are captured at a predetermined frame rate, which is based on capabilities one or more processors 250 (including an image signal processor) of the imaging system 204. While first, second, and third points in time are used for illustrative purposes, it should be understood that these points in time can also be part of ranges of time during which an exposure used to capture the image frame was open, such that the first point in time is a point in time when the exposure ends (so the exposure used to create the first captured image frame 302-1 lasts from a zero point in time until the first point in time, the exposure used to create the second captured image frame 302-2 lasts from the first point in time until the second point in time, etc.).

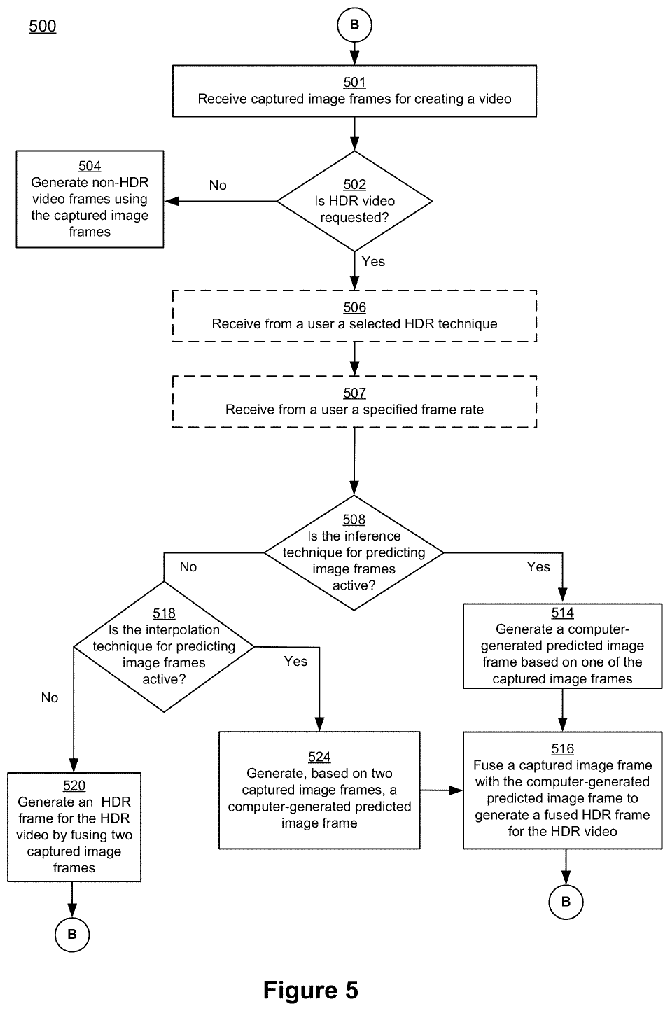

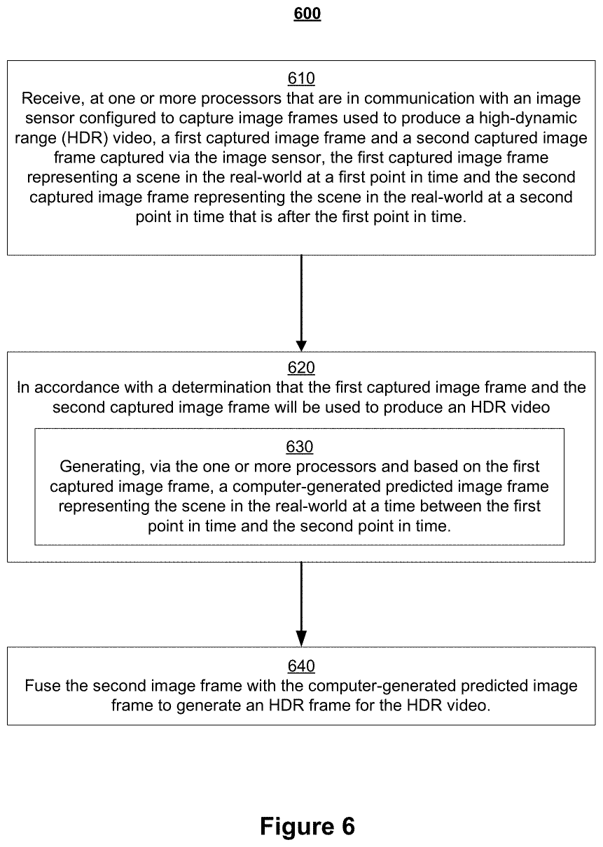

The example first, second, and third computer-generated predicted image frames 304-1, 304-2, and 304-3 (FIG. 3A) are generated using the inference-processing technique and one or more respective image frames 302. For example, the first computer-generated predicted image frame 304-1 is based on application of the inference-processing technique to the first captured image frame 302-1, the second computer-generated predicted image frame 304-2 is based on application of the inference-processing technique to the second captured image frame 302-2, and the third computer-generated predicted image frame 304-3 is based on application of the inference-processing technique to the third captured image frame 302-3. In some embodiments, application of the inference-processing technique includes providing the respective captured image frames to a machine-learning system (e.g., the machine-learning image processing hardware and software 245, FIG. 2) that has been trained using a training set consisting of a variety of image frames captured by an image device 204 (or any other device including an image sensor 225; FIG. 2) viewing different scenes in the real world. In some embodiments, upon receiving a request from a user to begin capturing an HDR video (e.g., before operation 501, FIG. 5 or before operation 610 of FIG. 6), a device including imaging system 204 can select an appropriate machine-learning model from among a plurality of available machine-learning models, and each available machine-learning model can be trained using a different training set of images (e.g., such that the device is able to select a machine-learning model that will be able to more accurately produce computer-generated predicted image frames by utilizing a machine-learning model that was trained using a training set that includes images with visual information similar to that being captured during an HDR video creation process).

The first, second, and third computer-generated predicted image frames 304-1, 304-2, and 304-3 represent predictions as to how a scene in the real-world should look at respective points in time, as determined by the appropriate machine-learning model being utilized. In some embodiments, the first computer-generated predicted image frame 304-1 represents a scene in the real-world at a point in time between respective points in time associated with the first and second captured image frames 302-1 and 302-2, the second computer-generated predicted image frame 304-2 represents a scene in the real-world at a point in time between respective points in time associated with the second and third captured image frames 302-2 and 302-3, and the third computer-generated predicted image frame 304-3 represents a scene in the real-world at a point in time between respective points in time associated with the third captured image frame 302-3 and a fourth captured image frame (not shown). Each computer-generated predicted image frame 304 is an estimation or approximation of an image frame before the subsequent image frame. For example, the first computer-generated predicted image frame 304-1 is an estimated or approximated frame before the second captured image frame 302-2, the second computer-generated predicted image frame 304-2 is an estimated or approximated frame before the third captured image frame 302-3, and so forth. In some embodiments, the computer-generated predicted image frames represent the scene in the real-world at a next point in time associated with a next captured image frame rather than representing the scene at intermediary points in time (e.g., instead of computer-generated predicted image frame 304-2 representing a scene in the real-world at a point in time between respective points in time associated with the second and third captured image frames 302-2 and 302-3, it can instead represent the scene at the third point in time associated with the third captured image frame 302-3). Some embodiments can make use computer-generated predicted image frames associated with intermediary points in time in addition to computer-generated predicted image frames associated with a next point in time associated with a next captured image frame.

In some embodiments, a computer-generated predicted image frame 304 is generated while a subsequent captured image frame 302 in the sequence of successive captured frames 302 is being captured by the imaging system 204. For example, in some embodiments, while the first computer-generated predicted image frame 304-1 is being generated, the imaging system 204 can begin capturing the second captured image frame 302-2. In this way, the imaging system 204 (or other device performing the inference-processing technique) is able to make efficient use of the available computing resources and continues to capture image frames 302 while also producing additional computer-generated frames 304.

The inference-processing technique generates the first, second, and third HDR output frames 306-1, 306-2, and 306-3 based on a fusion (or combination or merging) of the subsequent image frame (e.g., captured frame 302-2) with the computer-generated predicted image frame (e.g., predicted frame 304-1) that was generated in accordance with the inference-processing technique based on the previous image frame (e.g., captured frame 302-1). For example, the second HDR image frame 306-2 is generated based on a fusion of the second captured image frame 302-2 (the subsequent image frame in this example) with the first computer-generated predicted image frame 304-1 (the computer-generated predicted image frame based on the previous captured image frame 302-1 in this example), and the third fused frame 306-3 is generated based a fusion of the third captured image frame 302-3 (the subsequent image frame in this example) with the second computer-generated predicted image frame 304-2 (the computer-generated predicted image frame based on the previous captured image frame 302-2 in this example). Creation of the first HDR image frame 306-1 is followed by the second HDR image frame 306-2, which is followed by the third HDR image frame 306-3. The first, second, and third HDR output frames 306-1, 306-2, and 306-3 eventually form the complete HDR video. In some embodiments, as shown in FIG. 3A and 3B, each HDR output frame 306 is created by fusing a single computer-generated predicted image frame 304 with a captured image frame 302. In some embodiments, one or more captured image frames 302 are captured, in part, while an HDR output frame 306 is being generated. For example, the third captured image frame 302-3 is captured, in part, while the second HDR output frame 306-2 is being generated. In other words, capturing of image frames, predicting of image frames, and fusing of frames can each occur in parallel in some embodiments.

In some embodiments, the imaging system 204 (or other device performing the inference-processing technique) repeatedly receives captured image frames 302, generates computer-generated predicted image frames 304, and fuses respective pairs of captured image frames 302 and computer-generated predicted image frames 304 to produce respective HDR output frames 306 for the HDR video (e.g., HDR video 280; FIG. 2), such that the HDR video has a target fps. In some embodiments, the target fps is 32 frames per second (e.g., 8 HDR output frames in a 0.25-second-long video). In some embodiments, the target fps is equal to or greater than the predetermined frame rate of the imaging system 204 (or other device performing the inference-processing technique or a device that was previously used to produce an HDR video that is then further optimized to a have a higher frame rate using the techniques described herein).

In other words, by using the inference-processing technique (e.g., fusion of captured image frames 302 and computer-generated predicted image frames 304), the imaging system 204 (or other device performing the inference-processing technique) is able to produce HDR videos having higher fps than is normally achievable using captured image frames alone (due to the limitations of the capabilities of the one or more processors 250 of the imaging systems as described above in reference to FIG. 2). For example, as described above in reference to FIGS. 1A and 1B, frame rate of generated HDR videos, in some approaches, is halved from the frame rate of the original capture due to the necessity of waiting for capturing of a new pair of adjacent captured image frames to then generate an HDR output frame. In contrast, the inference-processing technique uses computer-generated predicted image frames 304 to increase the total number of image frames available to generate fused HDR output frames and, therefore, is able to improve frame rates achievable for HDR videos.

FIG. 3B illustrates video processing using predicted frames 310 and, in particular shows a sample a timeline of processing operations during video processing using predicted frames 310, including illustrating that the HDR video processing in accordance with technique 301 involves capturing image frames, generating computer-generated predicted image frames using the inference-processing technique, and then creating HDR output frames, in accordance with some embodiments. In particular, FIG. 3B illustrates the processing of a video over an example period (noted as “Video Length” in the label of FIG. 3B) of 0.25 seconds using the inference-processing technique. In some embodiments, an imaging system 204 (FIG. 2) captures one or more image frames (e.g., captured image frames 308-1 through 308-8, which can include the captured image frames 302 described above in reference to FIG. 3A, as well as additional captured image frames) over a video-length period of at least 0.25 seconds. The inference-processing technique is performed on the captured image frames 308 to generate computer-generated predicted image frames 310-1 through 310-8 (which can include the computer-generated predicted image frames 304 described above in reference to FIG. 3A, as well as additional computer-generated predicted image frames). FIG. 3B also shows that application of the inference-processing technique during video processing using predicted frames technique 301 includes fusing the computer-generated predicted image frames 310 with the captured image frames 308 to generate HDR image frames 312 for the HDR video as described above in reference to FIG. 3A.

In some embodiments, the captured image frames 308 have the same or different exposures. In some embodiments, a first set of the captured image frames 308 have a short exposure and a second set of the captured image frames 308 have a long exposure. For example, captured image frames 308-1, 308-3, 308-5, 308-7 are captured with a short exposure and captured image frames 308-2, 308-4, 308-6 and 308-8 are captured with a long exposure. In some embodiments, the captured image frames 308 alternate between using short and long exposures. The descriptions provided above concerning exposures, and in particular regarding short and long exposures provided in reference to FIGS. 1A and 1B, also apply here.

The inference-processing technique is configured to generate the computer-generated predicted image frames 310 (represented as “AI frames (F),” because the predicted frames are generated using machine-learning models, which are also referred to as a form of artificial intelligence (AI)) using the captured image frames 308. In some embodiments, the computer-generated predicted image frames 310 have the same or different exposures. In some embodiments, a first set of the computer-generated predicted image frames 310 have a short exposure and a second set of the computer-generated predicted image frames 310 have a long exposure. For example, in some embodiments, computer-generated predicted image frames 310-1, 310-3, 310-5, 310-7 have a short exposure and computer-generated predicted image frames 310-2, 310-4, 310-6 and 310-8 have a long exposure. In some embodiments, the exposure of the computer-generated predicted image frames 310 is based on the exposure of the respective captured image frames 308 used by the inference-processing technique to generate the computer-generated predicted image frames 310. Alternatively, in some embodiments, the exposure of the computer-generated predicted image frames 310 is determined by the inference-processing technique (i.e., the inference-processing technique can select an appropriate exposure to increase the overall accuracy of the computer-generated predicted image frames).

FIG. 3B also shows that the video processing using predicted frames technique 301 further fuses the computer-generated predicted image frames 310 and the captured image frames 308 to generate the HDR image frames for the HDR video (e.g., HDR image frames 312-1 through 312-8). The technique 301 is configured to generate at least as many HDR output frames as were initially captured by the imaging system 204. For example, as shown in FIG. 3B, the video captured by the imaging system 204 includes N image frames 308 in the 0.25 second video-length segment, and the technique 301 that is making use of the inference-processing technique is able to create a 0.25 second video-length segment for the HDR video that includes N HDR image frames 312. In some embodiments, the technique 301, when used with the inference-processing technique, can generate more fused HDR output frames 312 (referred to simply as “Out F#,” which refers to output (out) frame (F) number in FIG. 3B) than image frames 308 that were initially captured by the imaging system 204. For example, each captured image frame 308 can be used to generate at least two computer-generated predicted image frames 310 for either the same or different points in time, such that each additional computer-generated predicted image frame 310 can be used to generate additional HDR image frames 312. Some embodiments can also produce more fused HDR output frames 312 by, in addition to fusing captured image frames with computer-generated predicted image frames, one or both of fusing computer-generated predicted image frames with other computer-generated predicted image frames (e.g., adjacent computer-generated predicted image frames can be fused, such as fusing 310-0 with 310-1) and fusing captured image frames with other captured image frames (e.g., fusing adjacent captured image frames such as 308-1 with 308-2) and, in such embodiments, a determination can be made as to whether or not to make use of the more fused HDR output frames (such as by determining whether each of the more fused HDR output frames meets a quality criterion; and if any of the more fused HDR output frames does not meet the quality criterion, then that frame is not used as part of the produced HDR video).

As was explained above and as is shown in FIG. 3B, in some embodiments, the inference-processing technique generates HDR output frames 312 simultaneously with capture of the one or more image frames 308 (e.g., the processing proceeds in real-time). In this way, processing time is not lost waiting for additional image frames 308 to be captured and the time it takes to capture the image frames 308 is used efficiently to generate the computer-generated predicted image frames, thereby ensuring that the fps for an HDR video is improved. As described below, further techniques of fusing computer-generated image frames with each other and also fusing the capture image frames with each other can also help to further enhance the achievable fps output and quality for an HDR video, in accordance with some embodiments.

In some embodiments, the inference-processing technique can be used on an existing or stored video (which can either be a previously recorded video or can be a video received from another user) as was described above to allow for a form of retrofitting those existing or stored videos to allow them to have higher numbers of frames per second (e.g., by extracting the individual captured image frames, creating the computer-generated predicting image frames, and then fusing pairs of each to create a new HDR video with a higher number of frames per second).

While the technique 301 that involves use of the inference-processing technique for predicting image frames is shown and described in reference to FIGS. 3A and 3B for creating HDR videos, the skilled artisan, upon reading this disclosure, will appreciate that the inference-processing technique can also be applied to other types of videos, including low-light video captures and slow-motion or high-speed video, such that frames within these other types of videos can also be generated through the use of computer-generated predicted image frames based on captured image frames to allow for improved output characteristics for the produced videos. Some embodiments also involve performing aspects of the inference-processing techniques at different points in time (or even simultaneously) with other techniques (e.g., the interpolation-processing technique; FIGS. 4A and 4B) for generating videos as described herein. The example of a 0.25 second video-length snippet in the processing timeline of FIG. 3B is also just one non-limiting example to illustrate application of the techniques described herein, and it should be appreciated that any length of video can be processed using the inference-processing technique.

FIGS. 4A-4B provide more details concerning the use of improved HDR video-processing techniques, in particular FIG. 4A illustrates an ongoing process for creating computer-generated predicted image frames by using an interpolation-processing technique (which can include generating the predicted image frames based on at least two of the captured frames, as compared to the inference-processing technique generating predicted frames based on one captured frame) on one or more captured image frames, and then creating fused image frames based on the computer-generated predicted image frames and captured image frames, in accordance with some embodiments. The interpolation-processing technique is used by an imaging system 204 (FIG. 2) and/or other device communicatively coupled to the imaging system 204 (e.g., a server, a laptop, a smartphone, a smartwatch, a tablet, etc.) to process one or more captured image frames 302 (e.g., first, second, and third captured image frames 302-1, 302-2 and 302-3) captured by the imaging system 204 (as was explained earlier, the primary examples provided here for illustrative purposes relate to video processing that occurs in real-time as images are captured, but the techniques described herein can also be used to improve frame rates for existing HDR videos, such that the captured image frames could have been captured by an imaging device other than the imaging device 204, such as an imaging device of another user's device that was used to create an HDR video that is then sent to another user, e.g., a user of the device that includes the imaging device 204). Specifically, the one or more captured image frames 302 are used, in conjunction with the interpolation-processing technique, to generate one or more respective computer-generated predicted image frames (e.g., first, second, and third computer-generated predicted image frames 404-1, 404-2, and 404-3), which are fused with the one or more captured image frames 302 to create one or more fused output HDR output frames (e.g., first, second, and third fused HDR output frames 406-1, 406-2, and 406-3) for the HDR video as described in detail below. As is depicted in FIG. 4A, systems and devices making use of the interpolation-processing technique are capable of predicting an image frame using captured image frames at two distinct points in time (e.g., the first computer-generated predicted image frame 404-1 can be generated based on application of the interpolation-processing technique to the first and third captured image frames 302-1 and 302-3). In so doing, some embodiments are capable of producing more fused HDR output frames 406 that also have an increased quality and accuracy (e.g., using a backward and forward captured image frame 302 to reduce inaccuracies and errors in a computer-generated predicted image frame 404), such that a number of fused HDR output frames 406 can be equal to (and can even exceed) a number of captured frames in a given period of time (e.g., every quarter second) and that have improved quality and accuracy, which allows for producing an HDR video having a high number of fps (equaling or exceeding a number of frames per second at which captured images were captured) and improved accuracy.

As described above in reference to FIG. 3A, the first, second, and third captured image frames 302-1, 302-2 and 302-3 are representations of a scene in the real-world at a respective point in time. The captured image frames 302 are captured at a predetermined frame rate (e.g., 32 fps). As described below, the interpolation-processing technique uses each captured image frame 302 to interpolate at least a forward and backward looking computer-generated predicted image frame 404 (e.g., the first computer-generated predicted image frame 404-1 which is generated based on application of the interpolation-processing technique to the first and third captured image frames 302-1 and 302-3 and is configured to be fused with the second captured image frames 302-2, which is in between the first and third captured image frames 302-1 and 302-3). While first, second, and third points in time are used for illustrative purposes, it should be understood that these points in time can also be part of ranges of time during which an exposure used to capture the image frame was open, such that the first point in time is a point in time when the exposure ends (so the exposure used to create the first captured image frame 302-1 lasts from a zero point in time until the first point in time, the exposure used to create the second captured image frame 302-2 lasts from the first point in time until the second point in time, etc.).

The interpolation-processing technique uses the captured image frames 302 to generate the computer-generated predicted image frames 404. In particular, the interpolation-processing technique uses at least two captured image frames 302 to generate a computer-generated predicted image frame 404. For example, the first computer-generated predicted image frame 404-1 is based on application of the interpolation-processing technique to the first captured image frame 302-1 and the third captured image frame 302-3, the second computer-generated predicted image frame 404-2 is based on application of the interpolation-processing technique to the second captured image frame 302-2 and a fourth captured image frame (not shown), and the third computer-generated predicted image frame 404-3 is based on application of the interpolation-processing technique to the third captured image frame 302-3 and a fifth captured image frame (not shown). Although not shown, fourth captured image frame is captured at a fourth point in time that is after the third point of time of the third captured image frame 302-3, and the fourth captured image frame is followed by the fifth captured image frame that is captured at a fifth point in time. Additionally, each captured image frame 302 is used to interpolate at least a forward and backward looking computer-generated predicted image frame 404. For example, the third captured image frame 302-3 is used to generate the first and third computer-generated predicted image frame 404-1 and 404-3. In some embodiments, the interpolation-processing technique is part of a machine-learning system (e.g., the machine-learning image processing hardware and software 245, FIG. 2) that has been trained using a training set consisting of a variety of image frames captured by an image device 204 (or any other device including an image sensor 225; FIG. 2) viewing different scenes in the real world. In some embodiments, upon receiving a request from a user to begin capturing an HDR video (e.g., before operation 501, FIG. 5 or before operation 610 of FIG. 6), a device including imaging system 204 can select an appropriate machine-learning model from among a plurality of available machine-learning models, and each available machine-learning model can be trained using a different training set of images (e.g., such that the device is able to select a machine-learning model that will be able to more accurately produce computer-generated predicted image frames by utilizing a machine-learning model that was trained using a training set that includes images with visual information similar to that being captured during an HDR video creation process).

The first, second, and third computer-generated predicted image frames 404-1, 404-2, and 404-3 represent predictions as to how a scene in the real-world at respective points in time, as determined by the appropriate machine-learning model being utilized. In some embodiments, the first computer-generated predicted image frame 404-1 represents a scene in the real-world at a point in time between respective points in time associated with the first and second captured image frames 302-1 and 302-2, the second computer-generated predicted image frame 404-2 represents a scene in the real-world at a point in time between respective points in time associated with the second and third captured image frames 302-2 and 302-3, and the third computer-generated predicted image frame 404-3 represents a scene in the real-world at a point in time between respective points in time associated with the third captured image frame 302-3 and the fourth captured image frame. Each computer-generated predicted image frame 404 is an estimation or approximation of an image frame before a subsequent image frame. For example, the first computer-generated predicted image frame 404-1 is an estimated or approximated frame before the second captured image frame 302-2, the second computer-generated predicted image frame 404-2 is an estimated or approximated frame before the third captured image frame 302-3, and so forth. Because the interpolation-processing technique uses at least two captured image frames (e.g., one captured image frame at a first point in time and one captured image frame at a second point in time greater that the first point in time) to generate the computer-generated predicted image frame 404, the interpolation-processing technique generates estimated or approximated frames with higher accuracy (or less error) than the inference-processing technique. The increased accuracy and/or reduced error improves the overall quality of the created HDR video relative to the inference-processing technique.

In other words, the interpolation-processing technique can be used to further enhance the accuracy of the computer-generated predicted image frames by using both backward-looking (e.g., using the first captured image frame 302-1) and forward-looking (e.g., using the third captured image frame 302-3) inputs to predict what an image frame between the first point in time and the second point in time should looked like (e.g., the first computer-generated predicted image frame 404-1 represents a scene in the real-world at a point in time between the first and second captured image frames 302-1 and 302-2). Thus, an interpolative approach can be added to the inferential technique described above, which further enhances accuracy of the predicted image frames. In some embodiments, the computer-generated predicted image frames represent the scene in the real-world at a next point in time associated with a next captured image frame rather than representing the scene at intermediary points in time (e.g., instead of computer-generated predicted image frame 404-2 representing a scene in the real-world at a point in time between respective points in time associated with the second and third captured image frames 302-2 and 302-3, it can instead represent the scene at the third point in time associated with the third captured image frame 302-3). Some embodiments can make use computer-generated predicted image frames associated with intermediary points in time in addition to computer-generated predicted image frames associated with a next point in time associated with a next captured image frame.

The interpolation-processing technique generates the first, second, and third HDR output frames 406-1, 406-2, and 406-3 based on a fusion (or combination or merging) of the subsequent image frame (e.g., captured frame 302-2) with the computer-generated predicted image frame (e.g., predicted frame 404-1) that was generated in accordance with the interpolation-processing technique based on the previous image frame and a future image frame (e.g., first and third captured image frames 302-1 and 302-3). For example, the second HDR image frame 406-2 is generated based on a fusion of the second captured image frame 302-2 (the subsequent image frame in this example) with the first computer-generated predicted image frame 404-1 (the computer-generated predicted image frame based on the first and third captured image frames 302-1 and 302-3 in this example), and the third HDR image frame 406-3 is generated based a fusion of the third captured image frame 302-3 (the subsequent image frame in this example) with the second computer-generated predicted image frame 404-2 (the computer-generated predicted image frame based on the second and fourth captured image frames in this example). Creation of the first HDR image frame 406-1 is followed by the second HDR image frame 406-2, which is followed by the third HDR image frame 406-3. The first, second, and third HDR output frames 406-1, 406-2, and 406-3 eventually form the complete HDR video. In some embodiments, as shown in FIG. 4A and 4B, each HDR output frame 406 is created by fusing a single computer-generated predicted image frame 404 with a captured image frame 302. In some embodiments, one or more captured image frames 302 are captured, in part, while an HDR output frame 406 is being generated. For example, the third captured image frame 302-3 is captured, in part, while the first HDR output frame 406-1 is being generated. In other words, capturing of image frames, predicting of image frames, and fusing of frames can each occur in parallel in some embodiments.

In some embodiments, the imaging system 204 (or other device performing the inference-processing technique) repeatedly receives captured image frames 302, generates computer-generated predicted image frames 404, and fuses respective pairs of captured image frames 302 and computer-generated predicted image frames 404 to produce respective HDR output frames 406 for the HDR video (e.g., HDR video 280; FIG. 2), such that the HDR video has a target fps. In some embodiments, the target fps is 32 frames per second. In some embodiments, the target fps is equal to or greater than the predetermined frame rate of the imaging system 204 (or other device performing the interpolation-processing technique or a device that was previously used to produce an HDR video that is then further optimized to a have a higher frame rate using the techniques described herein).

In other words, the interpolation-processing technique, similar to the inference-processing technique, is able to produce HDR videos having higher fps than is normally achievable using captured image frames alone (due to the limitations of the capabilities of the one or more processors 250 of the imaging systems as described above in reference to FIG. 2). The interpolation-processing technique uses computer-generated predicted image frames 404 to increase the total number of image frames available to generate an HDR output frame with improved accuracy and, therefore, improving the video quality of the created HDR video.

FIG. 4B illustrates video processing using predicted frames 410 and, in particular, shows a sample timeline of processing operations during video processing using predicted frames 410, including illustrating that the HDR video processing in accordance with technique 401 involves capturing image frames, generating computer-generated predicted image frames using the interpolation-processing technique, and then creating HDR output frames, in accordance with some embodiments. In particular, FIG. 4B illustrates the processing of a video over an example period (noted as “Video Length” in the label of FIG. 3B) of 0.25 seconds using the interpolation-processing technique. In some embodiments, an imaging system 204 (FIG. 2) captures one or more image frames (e.g., captured image frames 308-1 through 308-8, which can include the captured image frames 302 described above in reference to FIG. 3A and 4A, as well as additional captured image frames) over a video-length period of at least 0.25 seconds. The interpolation-processing technique is performed on the captured image frames 308 to generate computer-generated predicted image frames 410-1 through 410-8 (which can include the computer-generated predicted image frames 404 described above in reference to FIG. 4A, as well as additional computer-generated predicted image frames). FIG. 4B also shows that application of the interpolation-processing technique during video processing using predicted frames technique 401 includes fusing the computer-generated predicted image frames 410 with the captured image frames 308 to generate HDR image frames 412 for the HDR video as described above in reference to FIG. 4A.

In some embodiments, the captured image frames 308 have the same or different exposures. In some embodiments, a first set of the captured image frames 308 have a short exposure and a second set of the captured image frames 308 have a long exposure. For example, captured image frames 308-1, 308-3, 308-5, 308-7 are captured with a short exposure and captured image frames 308-2, 308-4, 308-6 and 308-8 are captured with a long exposure. In some embodiments, the captured image frames 308 alternate between using short and long exposures. The descriptions provided above concerning exposures, and in particular regarding short and long exposures provided in reference to FIGS. 1A and 1B, also apply here.

The interpolation-processing technique is configured to generate the computer-generated predicted image frames 410 (represented as “AI frames (F),” because the predicted frames are generated using machine-learning models, which are also referred to as a form of AI) using at least two captured image frames 308. In some embodiments, the computer-generated predicted image frames 410 have the same or different exposures. In some embodiments, a first set of the computer-generated predicted image frames 410 have a short exposure and a second set of the computer-generated predicted image frames 410 have a long exposure. For example, in some embodiments, computer-generated predicted image frames 410-1, 410-3, 410-5, 410-7 have a short exposure and computer-generated predicted image frames 410-2, 410-4, 410-6 and 410-8 have a long exposure. In some embodiments, the exposure of the computer-generated predicted image frames 410 is based on the exposure of the respective captured image frames 308 used by the interpolation-processing technique to generate the computer-generated predicted image frames 410. In some embodiments, the computer-generated predicted image frames 410 can have a mixed exposure (e.g., a computer-generated predicted image frame 410 can be generated using a short exposure captured image frame and a long exposure captured image frame). Alternatively, in some embodiments, the exposure of the computer-generated predicted image frames 410 is determined by the interpolation-processing technique (i.e., the interpolation-processing technique can select an appropriate exposure to increase the overall accuracy of the computer-generated predicted image frames).

FIG. 4B also shows that the video processing using predicted frames technique 401 further fuses the computer-generated predicted image frames 410 and the captured image frames 308 to generate the HDR image frames for the HDR video (e.g., HDR image frames 412-1 through 412-8). The technique 401 is configured to generate at least as many HDR output frames as were initially captured by the imaging system 204. For example, as shown in FIG. 4B, the video captured by the imaging system 204 includes N image frames 308 in the 0.25 second video-length segment, and the technique 401 that is making use of the interpolation-processing technique is able to create a 0.25 second video-length segment for the HDR video that includes N HDR image frames 412. In some embodiments, the technique 401, when used with the interpolation-processing technique, can generate more fused HDR output frames 412 (referred to simply as “Out F#,” which refers to output (out) frame (F) number in FIG. 4B) than image frames 308 that were initially captured by the imaging system 204. For example, each captured image frame 308 can be used to generate at least two computer-generated predicted image frames 410 for either the same or different points in time, such that each additional computer-generated predicted image frame 410 can be used to generate additional HDR image frames 412. Some embodiments can also produce more fused HDR output frames 412 by, in addition to fusing captured image frames with computer-generated predicted image frames, one or both of fusing computer-generated predicted image frames with other computer-generated predicted image frames (e.g., adjacent computer-generated predicted image frames can be fused, such as fusing 410-0 with 410-1) and fusing captured image frames with other captured image frames (e.g., fusing adjacent captured image frames such as 308-1 with 308-2) and, in such embodiments, a determination can be made as to whether or not to make use of the more fused HDR output frames (such as by determining whether each of the more fused HDR output frames meets a quality criterion; and if any of the more fused HDR output frames does not meet the quality criterion, then that frame is not used as part of the produced HDR video).

As was explained above and as is shown in FIG. 4B, in some embodiments, the interpolation-processing technique generates HDR output frames 412 simultaneously with capture of the one or more image frames 308 (e.g., the processing proceeds in real-time). In this way, processing time is not lost waiting for additional image frames 308 to be captured and the time it takes to capture the image frames 308 is used efficiently to generate the computer-generated predicted image frames, thereby ensuring that the fps for an HDR video is improved. As described below, further techniques of fusing computer-generated image frames with each other and also fusing the capture image frames with each other can also help to further enhance the achievable fps output and quality for an HDR video, in accordance with some embodiments.

In some embodiments, the interpolation-processing technique can be used on an existing or stored video (which can either be a previously recorded video or can be a video received from another user) as was described above to allow for a form of retrofitting those existing or stored videos to allow them to have higher numbers of frames per second (e.g., by extracting the individual captured image frames, creating the computer-generated predicting image frames, and then fusing pairs of each to create a new HDR video with a higher number of frames per second).

While the technique 401 that involves use of the interpolation-processing technique for predicting image frames is shown and described in reference to FIGS. 4A and 4B for creating HDR videos, the skilled artisan, upon reading this disclosure, will appreciate that the interpolation-processing technique can also be applied to other types of videos, including low-light video captures and slow-motion or high-speed video, such that frames within these other types of videos can also be generated through the use of computer-generated predicted image frames based on captured image frames to allow for improved output characteristics for the produced videos. Some embodiments also involve performing aspects of the inference-processing techniques at different points in time (or even simultaneously) with other techniques (e.g., the inference-processing technique; FIGS. 3A and 3B) for generating videos as described herein. The example of a 0.25 second video-length snippet in the processing timeline of FIG. 4B is also just one non-limiting example to illustrate application of the techniques described herein, and it should be appreciated that any length of video can be processed using the inference-processing technique.

For example, in some embodiments, a first HDR image frame can be generated using the inference-processing technique described above in reference to FIGS. 3A and 3B, a second HDR image frame can be generated using the interpolation-processing technique described above in reference to FIGS. 4A and 4B, and/or a third HDR image frame can be generated using the approach described above in reference to FIGS. 1A and 1B. In some embodiments, an HDR video can have one or more HDR output frames generated using the inference-processing technique, one or more HDR output frames generated using the interpolation-processing technique, and/or one or more HDR output frames generated using the approach of FIGS. 1A-1B. An HDR video created using at least two of the inference-processing technique, the interpolation-processing technique, and/or the approach of FIGS. 1A-1B can have any number of HDR output frames generated by either technique or approach (i.e., there can be equal or unequal balances between the types of computer-generated predicted frames used to generate the HDR output frames). In some embodiments, the fps of a created HDR video (or non-HDR video) can be further increased by fusing both captured image frames with computer-generated image frames, as well as fusing computer-generated image frames with other computer-generated image frames. Alternatively, any number of computer-generated image frames can be generated between successive captured image frames to increase the total number of frames available for generating an HDR output frame (e.g., increasing the total number of computer-generated image frames that can be fused with captured image frames). In this way, an HDR video (or non-HDR video) can be created with a high number of frames per second.

FIG. 5 is a flow diagram showing a process for HDR video processing that makes use of either or both of the inference-processing and interpolation-processing techniques in conjunction with creation of an HDR video, in accordance with some embodiments. The HDR output frames are generated using one or more of the inference-processing technique (e.g., FIGS. 3A-3B), the interpolation-processing technique (e.g., FIGS. 4A-4B), and/or the technique of FIGS. 1A-1B as described above. Operations (e.g., steps) of the process 500 can be performed by one or more processors 250 (FIG. 2) of an imaging system 204. At least some of the operations shown in FIG. 5 correspond to instructions stored in a computer memory or computer-readable storage medium (e.g., memory 260; FIG. 2). Operations 501-524 can also be performed, in part, using one or more processors and/or using instructions stored in memory or computer-readable medium of one or more devices communicatively coupled to the imaging system 204 (e.g., such as a laptop, AR glasses, a server, a tablet, or other computing device that can perform operations 501-524 alone or in conjunction with the one or more processors of the imaging system 204).

As shown in FIG. 5, the process 500 is initiated when captured image frames for creating a video are received (501). The captured image frames include first and second captured image frames. The captured image frames are captured by the imaging system 204 or provided and stored in memory of the imaging system 204 (or other computing device). The captured image frames can be one or more image frames as described above in reference to FIGS. 1A-4B. In some embodiments, the captured image frames are captured at a predetermined frame rate (e.g., 32 fps, 64 fps, 90 fps, 120 fps, etc.). As described above in reference to FIG. 2, in some embodiments, the maximum predetermined frame rate is based on the one or more processors 250 of the imaging system 204 (or processors of a device capturing the captured image frames).

After receiving the captured image frames, the process 500 determines (502) whether an HDR video is requested by a user. In accordance with a determination that an HDR video is not requested (“No” at operation 502), the process 500 goes on to generate (504) non-HDR video frames using the captured image frames. Alternatively, in accordance with a determination that an HDR video is requested (“Yes” at operation 502), the process 500 goes on to generate the HDR video as discussed below. In some embodiments, the determination that an HDR video is requested is based on an HDR mode of the imaging system 204 being enabled or disabled. When the HDR mode is disabled, the process 500 makes a determination that an HDR video is not requested (“No” at operation 502) and goes on to generate (504) a non-HDR video based on the captured image frames. Alternatively, when the HDR mode is enabled, the process 500 makes a determination that an HDR video is requested (“Yes” at operation 502) and goes on to generate the HDR video as discussed below. In other words, in some embodiments, the process 500 determines (or checks) whether an HDR-video mode is enabled for the imaging system 204, such as a user having selected to produce HDR videos at a device that is used to manage an image sensor 225 (FIG. 2) of an imaging system 204, such as a smartphone or smart watch in which the image sensor 225 is embedded or a user interface (UI) that is used to manage a separate camera system that includes the image sensor 225 (such as a UI used to manage a security system that includes the image sensor).

In some embodiments, after the process 500 makes a determination that an HDR video is requested (“Yes” at operation 502), the process 500 receives (506) from the user a selected HDR technique. The selected technique can be one or more of the inference-processing technique, the interpolation-processing technique, the technique of FIGS. 1A-1B, and/or a combination thereof. Additionally, in some embodiments, the process 500 receives (507) from the user a specified frame rate. In some embodiments, the process 500 determines one or more of the inference-processing technique, the interpolation-processing technique, the technique of FIGS. 1A-1B, and/or a combination thereof to use on the captured image frames to achieve the specified frame rate.

At operation 508, the process 500 determines (508) whether the inference technique for predicting image frames is active. In accordance with a determination that the inference technique for predicting image frames is active (“Yes” at operation 508), the process 500, using the inference-processing technique, generates (514) a computer-generated predicted image frame based on one of the captured image frames. For example, as shown and described above in reference to FIG. 3A, the first computer-generated predicted image frame 304-1 is generated using the inference-processing technique on the first captured image frame 302-1. After the computer-generated predicted image frame is generated, the process 500 fuses (516) a captured image frame with the computer-generated predicted image frame to generate a fused HDR output frame for the HDR video. For example, as shown in FIG. 3A, the second HDR image frame 306-2 is generated based on a fusion of the second captured image frame 302-2 and the first computer-generated predicted image frame 304-1. After the fused HDR output frame for the HDR video is generated, the process 500 returns to operation 501 and repeats at least operations 508-524 for subsequently received captured image frames. In some embodiments, operations 502-507 are optional for the subsequently received captured image frames. By returning to operation 501 and repeating at least operations 508-524 for subsequently received captured image frames, the process 500 can further determine whether to use one or more of the inference-processing technique, the interpolation-processing technique, the technique of FIGS. 1A-1B, and/or a combination thereof to generate a subsequent fused HDR output frame. The subsequent fused HDR output frame follows the HDR output frame and eventually form the HDR video.

Returning to operation 508, in accordance with a determination that the inference technique for predicting image frames is not active (“No” at operation 508), the process 500 determines (518) whether the interpolation technique for predicting image frames is active. In accordance with a determination that the interpolation technique for predicting image frames is active (“Yes” at operation 518), the process 500, using the interpolation-processing technique, generates (524) a computer-generated predicted image frame based on at least two captured image frames. For example, as shown and described above in reference to FIG. 4A, the first computer-generated predicted image frame 404-1 is generated using the interpolation-processing technique on the first captured image frame 302-1 and the third captured image frame 302-3. After the computer-generated predicted image frame is generated, the process 500 fuses (516) a captured image frame with the computer-generated predicted image frame to generate a fused HDR output frame for the HDR video. For example, as shown in FIG. 4A, the second HDR image frame 406-2 is generated based on a fusion of the second captured image frame 302-2 and the first computer-generated predicted image frame 404-1. After the fused HDR output frame for the HDR video is generated, the process 500 returns to operation 501 and repeats at least operations 508-524 for subsequently received captured image frames. In some embodiments, operations 502-507 are optional for the subsequently received captured image frames. By returning to operation 501 and repeating at least operations 508-524 for subsequently received captured image frames, the process 500 can further determine whether to use one or more of the inference-processing technique, the interpolation-processing technique, the technique of FIGS. 1A-1B, and/or a combination thereof to generate a subsequent fused HDR output frame as described above.

Returning to operation 518, in accordance with a determination that the interpolation technique for predicting image frames is not active (“No” at operation 518), the process 500 goes on to generate a fused HDR output frame based on the technique of FIGS. 1A-1B. For example, the process 500 obtains and fuses the first captured image frame and the second captured image frame to generate a fused HDR output frame for the HDR video. After the HDR output frame for the HDR video is generated, the process 500 returns to operation 501 and repeats at least operations 508-524 for subsequently received captured image frames. In some embodiments, operations 502-507 are optional for the subsequently received captured image frames. By returning to operation 501 and repeating at least operations 508-524 for subsequently received captured image frames, the process 500 can further determine whether to use one or more of the inference-processing technique, the interpolation-processing technique, the technique of FIGS. 1A-1B, and/or a combination thereof to generate a subsequent fused HDR output frames as described above.

Process 500 continues to operate until an HDR video is created. The created HDR video has a predetermined frame rate of equal to or greater than the frame rate of the captured image frames. While the primary examples use computer-generated predicted image frames to improve generation of HDR videos, as was noted above, other video-processing modes can also take advantage of the use of predicted image frames as described herein, e.g., for video-processing modes including low-light video processing, slow-motion mode, etc. to allow for improving frame rates for these other video-processing modes, which would make use of a similar flow diagram as that shown for FIG. 5.

FIG. 6 illustrates a method of using computer-generated predicted image frames to create an HDR video having a high number of frames per second (fps), in accordance with some embodiments. In some embodiments, a high number of fps means an fps equal to or greater than an fps that can be achieved by one or more processors (e.g., one or more processors 250; FIG. 2), such as 32 fps or higher, 64 fps or higher, etc. Operations (e.g., steps) of the method 600 may be performed by one or more processors of an imaging system (e.g., processor 250 of an imaging system 204; FIG. 2 or processor 826, FIG. 8). In some embodiments, the imaging system 204 includes an image sensor 225 (FIG. 2) to perform the one or more operations of method 600. At least some of the operations shown in FIGS. 6 correspond to instructions stored in a computer memory or computer-readable storage medium (e.g., memory 260 (FIG. 2), or storage 802; FIG. 8). Operations 610-640 can also be performed, in part, using one or more processors and/or using instructions stored in memory or computer-readable medium of a computing device (such as a server, laptop, tablet, etc. that can perform operations 610-640 alone or in conjunction with the one or more processors of the wearable device).

The method 600 includes receiving (610), at one or more processors that are in communication with an image sensor configured to capture image frames used to produce an HDR video, a first captured image frame and a second captured image frame captured via the image sensor. The first captured image frame represents a scene in the real-world at a first point in time and the second captured image frame represents the scene in the real-world at a second point in time that is after the first point in time. For example, the one or more processors 250 of the imaging system 204 that are in communication with an image sensor 225 (FIG. 2) are configured to receive captured image frames (e.g., captured image frame 302) that are used to produce an HDR video. Additional examples of the captured image frames are provided above in reference to FIGS. 3A-4B.

The method 600 includes, in accordance with a determination (620) that the first captured image frame and the second captured image frame will be used to produce an HDR video, generating (630), via the one or more processors and based on the first captured image frame, a computer-generated predicted image frame representing the scene in the real-world at a time between the first point in time and the second point in time. For example, as shown and described above in reference to FIGS. 3A and 3B, an inference-processing technique can be used to generate computer-generated predicted image frames 304. In some embodiments, the computer-generated predicted image frame is generated while the second captured image frame is being captured by the image sensor.

In some embodiments, the first captured image frame is a first type of image frame, the second captured image frame is a second type of image frame, and the first type of image frame is distinct from the second type of image frame. For example, in some embodiments, the first type of image frame is a first format (e.g., PNG, JPEG, RAW, etc.) and the second type of image frame is a second file format distinct from the first file format. Alternatively, in some embodiments, the first type of image frame has a first resolution (e.g., 1080p, 1440p, 4K, etc.) and the second type of image frame is a second resolution distinct from the first resolution. The types of image frames can include different layout (portrait, landscape, etc.), images captured using different lenses or image sensors, and/or different capture modes (e.g., low light capture mode, burst mode, panoramic mode, etc.). In some embodiments, the first captured image frame is a short exposure frame, and the second captured image frame is a long exposure frame.

Method 600 further includes fusing 640 the second image frame with the computer-generated predicted image frame to generate an HDR frame for the HDR video. For example, as shown and described above in reference to FIGS. 3A and 3B, an inference-processing technique generates and HDR frame sing the generate a computer-generated predicted image frames 304 and a captured image frame 302. In some embodiments, the one or more processors that are in communication with the image sensor receive a third captured image frame representing the scene in the real-world at a third point in time that is after the second point in time, and the third captured image frame is captured in part while the HDR frame is being generated.

In some embodiments, the method 600 includes repeating the receiving captured image frames, generating computer-generated predicted image frames, and fusing captured image frames and computer-generated predicted image frame to produce respective HDR frames for the HDR video, such that the HDR video has at least 32 frames per second. In some embodiments, the method 600 includes a first HDR frame that was created by fusing two captured image frames, and a second HDR frame that was created by fusing two computer-generated predicted image frames.

In some embodiments, the method 600 includes after producing the HDR video, receiving captured image frames captured via the image sensor and producing a non-HDR video without using any computer-generated predicted image frames, wherein the HDR video has a first number of frames that is greater than or equal to a second number of frames for the non-HDR video. In some embodiments, the first number of frames and the second number of frames is 32 frames. The technique of FIGS. 1A-1B generates HDR videos having significantly less fps output than non-HDR videos, such as only 16 fps for an HDR video as compared to 32 fps for a non-HDR video. In contrast, the method 600 is able to generate HDR videos without reducing the fps as is the case in traditional methods.

In some embodiments, the computer-generated predicted image frame is a first computer-generated predicted image frame and the HDR frame is a first HDR frame, and the method 600 further includes receiving, at the one or more processors that are in communication with the image sensor, a third captured image frame captured via the image sensor. The third captured image frame represents the scene in the real-world at a third point in time that is after the second point in time. The method 600 further includes, in accordance with a determination that the third captured image frame will be used in conjunction with the first captured image frame and the second captured image frame to pro-duce the HDR video, generating, via the one or more processors and based on the second captured image frame, a second computer-generated predicted image frame representing the scene in the real-world at the time between the second point in time and the third point in time and fusing the third image frame with the second computer-generated predicted image frame to generate a second HDR frame for the HDR video. The second HDR frame follows the first HDR frame in a sequence of HDR frames that eventually forms the complete HDR video.

In some embodiments, the method 600 further includes receiving, at the one or more processors that are in communication with the image sensor, a third captured image frame captured via the image sensor, the third captured image frame representing the scene in the real-world at a third point in time that is after the second point in time. In accordance with a determination that the third captured image frame will be used in conjunction with the first captured image frame and the second captured image frame to produce the HDR video, the method 600 further includes generating, via the one or more processors and based on the first captured image frame and the third captured image frame, the computer-generated predicted image frame representing the scene in the real-world at the time between the first point in time and the second point in time, and fusing the computer-generated predicted image frame with the second image frame and the computer-generated predicted image frame to generate the HDR frame for the HDR video.

In other words, an interpolation technique can be used to further enhance the accuracy of the computer-generated predicted image frames by using both backward-looking (using the first captured image frame) and forward-looking (using the third captured image frame) inputs to predict what an image frame between the first point in time and the second point in time should have looked like (e.g., as shown and described above in reference to FIGS. 4A and 4B). Thus, an interpolative approach can be added to the inferential technique described above, which further enhances accuracy of the predicted image frames.

In some embodiments, the computer-generated predicted image frame is a first computer-generated predicted image frame and the HDR frame is a first HDR frame, and the method 600 further includes receiving, at the one or more processors that are in communication with the image sensor, a fourth captured image frame captured via the image sensor, the fourth captured image frame representing the scene in the real-world at a fourth point in time that is after the third point in time. The method 600 further includes, in accordance with a determination that the fourth captured image frame will be used in conjunction with the first captured image frame; the second captured image frame; and the third captured image frame to produce the HDR video, generating, via the one or more processors and based on the second captured image frame and the fourth captured image frame, a second computer-generated predicted image frame representing the scene in the real-world at the time between the third point in time and the second point in time. The method 600 further includes fusing the third image frame with the second computer-generated predicted image frame to generate a second HDR frame for the HDR video. In some embodiments, each frame is used to interpolate a forward and backward looking computer-generated predicted image frame (as described above in reference to FIGS. 4A and 4B).

In some embodiments, the computer-generated predicted image frame is generated via a machine-learning system that has been trained using a training set consisting of a variety of image frames captured by an image sensor viewing different scenes in the real world.

In some embodiments, the HDR video has a number of fps that is at least equal to a maximum fps achievable by the one or more processors when using captured image frames to produce a video (e.g., as described above in reference to FIG. 2). In some embodiments, the HDR video has a fps greater than a maximum fps achievable by the one or more processors when using captured image frames to produce a video. In other words, by using computer-generated predicted image frames, method 600 is able to produce videos (including HDR videos) having higher numbers of fps than is normally achievable using captured image frames alone.

FIGS. 7A and 7B illustrate one non-limiting example of a device (e.g., a wrist-wearable device 750) that can be used in conjunction with the video-processing techniques described herein, in accordance with some embodiments. The wrist-wearable device 750 is an instance of the imaging system 204 described above in reference to FIGS. 2-6, such that imaging system 204 should be understood to have the features of wrist-wearable device 750 and vice versa. FIG. 7A illustrates a perspective view of the wrist-wearable device 750 that includes a watch body 754 decoupled from a watch band 762. In some embodiments, one or more components described above in reference to the imaging system 204 are included within the watch body (or capsule) 754 and/or the band 762 of the wrist-wearable device 750. Watch body 754 and watch band 762 can have a substantially rectangular or circular shape and can be configured to allow a user to wear the wrist-wearable device 750 on a body part (e.g., a wrist). The wrist-wearable device 750 can include a retaining mechanism 763 (e.g., a buckle, a hook and loop fastener, etc.) for securing watch band 762 to the user's wrist. The wrist-wearable device 750 can also include a coupling mechanism 760 (e.g., a cradle) for detachably coupling capsule or watch body 754 (via a coupling surface 756 of the watch body 754) to watch band 762.

The wrist-wearable device 750 can perform various functions and operations with reference to FIGS. 1A-6. As will be described in more detail below with reference to FIG. 8, functions executed by the wrist-wearable device 750 can include, without limitation, display of visual content to the user (e.g., visual content displayed on display screen 220), sensing user input (e.g., sensing a touch on button 758, sensing biometric data on sensor 764, sensing neuromuscular signals on neuromuscular sensor 765, etc.), messaging (e.g., text, speech, video, etc.), image capture, wireless communications (e.g., cellular, near field, Wi-Fi, personal area network, etc.), location determination, financial transactions, providing haptic feedback, alarms, notifications, biometric authentication, health monitoring, sleep monitoring, etc. These functions can be executed independently in watch body 754, independently in watch band 762, and/or in communication between watch body 754 and watch band 762. In some embodiments, functions can be executed on the wrist-wearable device 750 in conjunction with an artificial-reality environment which includes, but is not limited to, virtual-reality (VR) environments (including non-immersive, semi-immersive, and fully-immersive VR environments), augmented-reality environments (including marker-based augmented-reality environments, markerless augmented-reality environments, location-based augmented-reality environments, and projection-based augmented-reality environments), hybrid reality, and other types of mixed-reality environments. As the skilled artisan will appreciate upon reading the descriptions provided herein, the novel wearable devices described herein can be used with any of these types of artificial-reality environments.

The watch band 762 can be configured to be worn by a user such that an inner surface of the watch band 762 is in contact with the user's skin. When worn by a user, sensor 764 is in contact with the user's skin. The sensor 764 can be a biosensor that senses a user's heart rate, saturated oxygen level, temperature, sweat level, muscle intentions, or a combination thereof. The watch band 762 can include multiple sensors 764 that can be distributed on an inside and/or an outside surface of the watch band 762. Additionally, or alternatively, the watch body 754 can include the same or different sensors than the watch band 762 (or the watch band 762 can include no sensors at all in some embodiments). For example, multiple sensors can be distributed on an inside and/or an outside surface of watch body 754. As described below with reference to FIG. 8, the watch body 754 can include, without limitation, front-facing image sensor 725A and/or rear-facing image sensor 725B (each an instance of image sensor 135; FIGS. 1A-1F), a biometric sensor, an IMU, a heart rate sensor, a saturated oxygen sensor, a neuromuscular sensor(s) (e.g., EMG sensors 846 FIG. 8), an altimeter sensor, a temperature sensor, a bioimpedance sensor, a pedometer sensor, an optical sensor, a touch sensor, a sweat sensor, etc. The sensor 764 can also include a sensor that provides data about a user's environment including a user's motion (e.g., an IMU), altitude, location, orientation, gait, or a combination thereof. The sensor 764 can also include a light sensor (e.g., an infrared light sensor, a visible light sensor) that is configured to track a position and/or motion of watch body 754 and/or watch band 762. Watch band 762 can transmit the data acquired by the sensor 764 to watch body 754 using a wired communication method (e.g., a UART, a USB transceiver, etc.) and/or a wireless communication method (e.g., near field communication, Bluetooth™, etc.). Watch band 762 can be configured to operate (e.g., to collect data using sensor 764) independent of whether watch body 754 is coupled to or decoupled from watch band 762.

The watch band 762 and/or watch body 754 can include a haptic device 766 (e.g., a vibratory haptic actuator) that is configured to provide haptic feedback (e.g., a cutaneous and/or kinesthetic sensation, etc.) to the user's skin. The sensor 764 and/or haptic device 766 can be configured to operate in conjunction with multiple applications including, without limitation, health monitoring, social media, game playing, and artificial reality (e.g., the applications associated with artificial reality).

In some examples, the watch band 762 can include a neuromuscular sensor 765 (e.g., an electromyography (EMG) sensor, a mechanomyogram (MMG) sensor, a sonomyography (SMG) sensor, etc.). Neuromuscular sensor 765 can sense a user's intention to perform certain motor actions. The sensed muscle intention can be used to control certain user interfaces displayed on the display 220 of the wrist-wearable device 750 and/or can be transmitted to device responsible for rendering an artificial-reality environment (e.g., a head-worn wearable device) to perform an action in an associated artificial-reality environment, such as to control the motion of a virtual device displayed to the user.

Signals from neuromuscular sensor 765 can be used to provide a user with an enhanced interaction with a physical object and/or a virtual object in an artificial-reality application generated by an artificial-reality system (e.g., user interface objects presented on the display 220, or another computing device (e.g., a head-worn wearable device, such as smart glasses)). Signals from neuromuscular sensor 765 can be obtained (e.g., sensed and recorded) by one or more neuromuscular sensors 765 of watch band 762. Although FIG. 7A shows one neuromuscular sensor 765, watch band 762 can include a plurality of neuromuscular sensors 765 arranged circumferentially on an inside surface of watch band 762 such that the plurality of neuromuscular sensors 765 contact the skin of the user. Watch band 762 can include a plurality of neuromuscular sensors 765 arranged circumferentially on an inside surface of watch band 762. Neuromuscular sensor 765 can sense and record neuromuscular signals from the user as the user performs muscular activations (e.g., movements, gestures, etc.). The muscular activations performed by the user can include static gestures, such as placing the user's hand palm down on a table; dynamic gestures, such as grasping a physical or virtual object; and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The wrist-wearable device 750 can include a coupling mechanism (also referred to as a cradle) for detachably coupling watch body 754 to watch band 762. A user can detach watch body 754 from watch band 762 in order to reduce the encumbrance of the wrist-wearable device 750 to the user. The wrist-wearable device 750 can include a coupling surface 756 on the watch body 754 and/or coupling mechanism(s) 760 (e.g., a cradle, a tracker band, a support base, a clasp). A user can perform any type of motion to couple watch body 754 to watch band 762 and to decouple watch body 754 from watch band 762. For example, a user can twist, slide, turn, push, pull, or rotate watch body 754 relative to watch band 762, or a combination thereof, to attach watch body 754 to watch band 762 and to detach watch body 754 from watch band 762.

As shown in the example of FIG. 7A, watch band coupling mechanism 760 can include a type of frame or shell that allows watch body 754 coupling surface 756 to be retained within watch band coupling mechanism 760. Watch body 754 can be detachably coupled to watch band 762 through a friction fit, magnetic coupling, a rotation-based connector, a shear-pin coupler, a retention spring, one or more magnets, a clip, a pin shaft, a hook and loop fastener, or a combination thereof. In some examples, watch body 754 can be decoupled from watch band 762 by actuation of release mechanism 770. The release mechanism 770 can include, without limitation, a button, a knob, a plunger, a handle, a lever, a fastener, a clasp, a dial, a latch, or a combination thereof.

The wrist-wearable device 750 can include a single release mechanism 770 or multiple release mechanisms 770 (e.g., two release mechanisms 770 positioned on opposing sides of the wrist-wearable device 750 such as spring-loaded buttons). As shown in FIG. 7A, the release mechanism 770 can be positioned on watch body 754 and/or watch band coupling mechanism 760. Although FIG. 7A shows release mechanism 770 positioned at a corner of watch body 754 and at a corner of watch band coupling mechanism 760, the release mechanism 770 can be positioned anywhere on watch body 754 and/or watch band coupling mechanism 760 that is convenient for a user of wrist-wearable device 750 to actuate. A user of the wrist-wearable device 750 can actuate the release mechanism 770 by pushing, turning, lifting, depressing, shifting, or performing other actions on the release mechanism 770. Actuation of the release mechanism 770 can release (e.g., decouple) the watch body 754 from the watch band coupling mechanism 760 and the watch band 762 allowing the user to use the watch body 754 independently from watch band 762. For example, decoupling the watch body 754 from the watch band 762 can allow the user to capture images using rear-facing image sensor 725B.

FIG. 7B is a side view of another example of the wrist-wearable device 750. The wrist-wearable device 750 of FIG. 7B can include a watch body interface 780 (another example of a cradle for the capsule portion of the wrist-wearable device 750). The watch body 754 can be detachably coupled to the watch body interface 780. Watch body 754 can be detachably coupled to watch body interface 780 through a friction fit, magnetic coupling, a rotation-based connector, a shear-pin coupler, a retention spring, one or more magnets, a clip, a pin shaft, a hook and loop fastener, or a combination thereof.

In some examples, watch body 754 can be decoupled from watch body interface 780 by actuation of a release mechanism. The release mechanism can include, without limitation, a button, a knob, a plunger, a handle, a lever, a fastener, a clasp, a dial, a latch, or a combination thereof. In some examples, the wristband system functions can be executed independently in watch body 754, independently in watch body interface 780, and/or in communication between watch body 754 and watch body interface 780. Watch body interface 780 can be configured to operate independently (e.g., execute functions independently) from watch body 754. Additionally, or alternatively, watch body 754 can be configured to operate independently (e.g., execute functions independently) from watch body interface 780. As will be described in more detail below with reference to the block diagram of FIG. 8, watch body interface 780 and/or watch body 754 can each include the independent resources required to independently execute functions. For example, watch body interface 780 and/or watch body 754 can each include a power source (e.g., a battery), a memory, data storage, a processor (e.g., a CPU), communications, a light source, and/or input/output devices.

In this example, watch body interface 780 can include all of the electronic components of watch band 762. In additional examples, one or more electronic components can be housed in watch body interface 780 and one or more other electronic components can be housed in portions of watch band 762 away from watch body interface 780.

FIG. 8 is one non-limiting block diagram of a device (e.g., a wrist-wearable device system 800) that can be used in conjunction with the video-processing techniques described herein, according to at least one embodiment of the present disclosure. The imaging system 204 and/or wrist-wearable device 750 described in detail above is an example wrist-wearable device system 800, so imaging system 204 and/or wrist-wearable device 750 will be understood to include the components shown and described for system 800 below. The wrist-wearable device system 800 can have a split architecture (e.g., a split mechanical architecture, a split electrical architecture) between a watch body 804 (e.g., a capsule or watch body 754) and a watch band 812 (e.g., a band portion 762), which was described above in reference to FIGS. 7A and 7B. Each of watch body 804 and watch band 812 can have a power source, a processor, a memory, sensors, a charging device, and a communications device that enables each of watch body 804 and watch band 812 to execute computing, controlling, communication, and sensing functions independently in watch body 804, independently in watch band 812, and/or in communication between watch body 804 and watch band 812.

For example, watch body 804 can include capacitive sensor 877, magnetic field sensor, antenna return-loss (RL) sensor, biometric sensor, battery 828, CPU 826, storage 802, heart rate sensor 858, EMG sensor 846, SpO2 sensor 854, altimeter 848, IMU 842, random access memory 803, charging input 830 and communication devices NFC 815, LTE 818, and WiFi/Bluetooth 820. Similarly, watch band 812 can include battery 838, microcontroller unit 852, memory 850, heart rate sensor 858, EMG sensor 846, SpO2 sensor 854, altimeter 848, IMU 842, charging input 834 and wireless transceiver 840. In some examples, a level of functionality of at least one of watch band 812 or watch body 804 can be modified when watch body 804 is detached from watch band 812. The level of functionality that can be modified can include the functionality of at least one sensor (e.g., heart rate sensor 858, EMG sensor 846, etc.). Each of watch body 804 and watch band 812 can execute instructions stored in storage 802 and memory 850 respectively that enables at least one sensor (e.g., heart rate sensor 858, EMG sensor 846, etc.) in watch band 812 to acquire data when watch band 812 is detached from watch body 804 and when watch band 812 is attached to watch body 804.

Watch body 804 and watch band 812 can further execute instructions stored in storage 802 and memory 850 respectively that enables watch band 812 to transmit the acquired data to watch body 804 (or other computing device such as a head mounted display or other computing device communicatively coupled to the wrist-wearable device system 800) using wired communications 827 and/or wireless transceiver 840. For example, watch body 804 can display visual content to a user on touchscreen display 813 (e.g., an instance of display 220) and play audio content on speaker 874. Watch body 804 can receive user inputs such as audio input from microphone 872 and touch input from buttons 824. Watch body 804 can also receive inputs associated with a user's location and/or surroundings. For example, watch body 804 can receive location information from GPS 816 and/or altimeter 848 of watch band 812.

Watch body 804 can receive image data (e.g., captured image frames) from at least one image sensor 135 (e.g., a camera). Image sensor 135 can include front-facing image sensor 725A (FIG. 7A) and/or rear-facing image sensor 725B (FIG. 7B). Front-facing image sensor 725A and/or rear-facing image sensor 725B can capture wide-angle images of the area surrounding front-facing image sensor 725A and/or rear-facing image sensor 725B such as hemispherical images (e.g., at least hemispherical, substantially spherical, etc.), 180-degree images, 360-degree area images, panoramic images, ultra-wide area images, or a combination thereof. In some examples, front-facing image sensor 725A and/or rear-facing image sensor 725B can be configured to capture images having a range between 45 degrees and 360 degrees. Certain input information received by watch body 804 (e.g., user inputs, etc.) can be communicated to watch band 812. Similarly, certain input information (e.g., acquired sensor data, neuromuscular sensor data, etc.) received by watch band 812 can be communicated to watch body 804.

Watch body 804 and watch band 812 can receive a charge using a variety of techniques. In some embodiments, watch body 804 and watch band 812 can use a wired charging assembly (e.g., power cords) to receive the charge. Alternatively, or in addition, watch body 804 and/or watch band 812 can be configured for wireless charging. For example, a portable charging device can be designed to mate with a portion of watch body 804 and/or watch band 812 and wirelessly deliver usable power to a battery of watch body 804 and/or watch band 812.

Watch body 804 and watch band 812 can have independent power and charging sources to enable each to operate independently. Watch body 804 and watch band 812 can also share power (e.g., one can charge the other) via power management IC 832 in watch body 804 and power management IC 836 in watch band 812. Power management IC 832 and power management IC 836 can share power over power and ground conductors and/or over wireless charging antennas.

Wrist-wearable device system 800 can operate in conjunction with a health monitoring application that acquires biometric and activity information associated with the user. The health monitoring application can be designed to provide information to a user that is related to the user's health. For example, wrist-wearable device system 800 can monitor a user's physical activity by acquiring data from IMU 842 while simultaneously monitoring the user's heart rate via heart rate sensor 858 and saturated blood oxygen levels via SpO2 sensor 854. CPU 826 can process the acquired data and display health related information to the user on touchscreen display 813.

Wrist-wearable device system 800 can detect when watch body 804 and watch band 812 are connected to one another (e.g., mechanically connected and/or electrically or magnetically connected) or detached from one another. For example, pin(s), power/ground connections 860, wireless transceiver 840, and/or wired communications 827, can detect whether watch body 804 and watch band 812 are mechanically and/or electrically or magnetically connected to one another (e.g., detecting a disconnect between the one or more electrical contacts of power/ground connections 860 and/or wired communications 827). In some examples, when watch body 804 and watch band 812 are mechanically and/or electrically disconnected from one another (e.g., watch body 812 has been detached from watch band 812 as described with reference to FIGS. 7A and 7B), watch body 804 and/or watch band 812 can operate with modified level of functionality (e.g., reduced functionality) as compared to when watch body 804 and watch band 812 are mechanically and/or electrically connected to one another. The modified level of functionality (e.g., switching from full functionality to reduced functionality and from reduced functionality to full functionality) can occur automatically (e.g., without user intervention) when wrist-wearable device system 800 determines that watch body 804 and watch band 812 are mechanically and/or electrically disconnected from one another and connected to each other, respectively.

Modifying the level of functionality (e.g., reducing the functionality in watch body 804 and/or watch band 812) can reduce power consumption in battery 828 and/or battery 838. For example, any of the sensors (e.g., heart rate sensor 858, EMG sensor 846, SpO2 sensor 854, altimeter 848, etc.), processors (e.g., CPU 826, microcontroller unit 852, etc.), communications elements (e.g., NFC 815, GPS 816, LTE 818, WiFi/Bluetooth™ 820, etc.), or actuators (e.g., haptics 822, 849, etc.) can reduce functionality and/or power consumption (e.g., enter a sleep mode) when watch body 804 and watch band 812 are mechanically and/or electrically disconnected from one another. Watch body 804 and watch band 812 can return to full functionality when watch body 804 and watch band 812 are mechanically and/or electrically connected to one another. The level of functionality of each of the sensors, processors, actuators, and memory can be independently controlled.

As described above, wrist-wearable device system 800 can detect when watch body 804 and watch band 812 are coupled to one another (e.g., mechanically connected and/or electrically connected) or decoupled from one another. In some examples, watch body 804 can modify a level of functionality (e.g., activate and/or deactivate certain functions) based on whether watch body 804 is coupled to watch band 812. For example, CPU 826 can execute instructions that detect when watch body 804 and watch band 812 are coupled to one another and activate front-facing image sensor 725A. CPU 826 can activate front-facing image sensor 725A based on receiving user input (e.g., a user touch input from touchscreen display 813, a user voice command from microphone 872, a user gesture recognition input from EMG sensor 846, etc.).

When CPU 826 detects that watch body 804 and watch band 812 are decoupled from one another, CPU 826 can modify a level of functionality (e.g., activate and/or deactivate additional functions). For example, CPU 826 can detect when watch body 804 and watch band 812 are decoupled from one another and activate rear-facing image sensor 725B. CPU 826 can activate rear-facing image sensor 725B automatically (e.g., without user input) and/or based on receiving user input (e.g., a touch input, a voice input, an intention detection, etc.). Automatically activating rear-facing image sensor 725B can allow a user to take wide-angle images without having to provide user input to activate rear-facing image sensor 725B.

In some examples, rear-facing image can be activated based on an image capture criterion (e.g., an image quality, an image resolution, etc.). For example, rear-facing image sensor 725B can receive an image (e.g., a test image). CPU 826 and/or rear-facing image sensor 725B can analyze the received test image data and determine whether the test image data satisfies the image capture criterion (e.g., the image quality exceeds a threshold, the image resolution exceeds a threshold, etc.). Rear-facing image sensor 725B can be activated when the test image data satisfies the image capture criterion. Additionally, or alternatively, rear-facing image sensor 725B can be deactivated when the test image data fails to satisfy the image capture criterion.

In some examples, CPU 826 can detect when watch body 804 is coupled to watch band 812 and deactivate rear-facing image sensor 725B. CPU 826 can deactivate rear-facing image sensor 725B automatically (e.g., without user input) and/or based on receiving user input (e.g., a touch input, a voice input, an intention detection, etc.). Deactivating rear-facing image sensor 725B can automatically (e.g., without user input) reduce the power consumption of watch body 804 and increase the battery charge time in watch body 804. In some examples, wrist-wearable device system 800 can include a coupling sensor 807 that senses whether watch body 804 is coupled to or decoupled from watch band 812. Coupling sensor 807 can be included in any of watch body 804, watch band 812, or watch band coupling mechanism 760 of FIGS. 7A and 7B. Coupling sensor 807 (e.g., a proximity sensor) can include, without limitation, an inductive proximity sensor, a limit switch, an optical proximity sensor, a capacitive proximity sensor, a magnetic proximity sensor, an ultrasonic proximity sensor, or a combination thereof. CPU 826 can detect when watch body 804 is coupled to watch band 812 or decoupled from watch band 812 by reading the status of coupling sensor 807.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of using computer-generated predicted image frames to create a high-dynamic-range (HDR) video having a high number of frames per second (fps), the method comprising:
receiving, at one or more processors that are in communication with an image sensor configured to capture image frames used to produce a high-dynamic range (HDR) video, a first captured image frame and a second captured image frame captured via the image sensor, the first captured image frame representing a scene in the real-world at a first point in time and the second captured image frame representing the scene in the real-world at a second point in time that is after the first point in time;
in accordance with a determination that the first captured image frame and the second captured image frame will be used to produce an HDR video:
generating, via the one or more processors and based on the first captured image frame, a computer-generated predicted image frame representing the scene in the real-world at a time between the first point in time and the second point in time; and
fusing the second captured image frame with the computer-generated predicted image frame to generate an HDR frame for the HDR video.

2. The method of claim 1, further comprising repeating the receiving captured image frames, the generating computer-generated predicted image frames, and the fusing computer-generated predicted image frames with captured image frames to produce respective HDR frames for the HDR video, such that the HDR video has at least 32 frames per second.

3. The method of claim 2, wherein the HDR video includes:
(i) a first HDR frame that was created by fusing two captured image frames, and
(ii) a second HDR frame that was created by fusing two computer-generated predicted image frames.

4. The method of claim 1, further comprising:
after producing the HDR video, receiving captured image frames captured via the image sensor and producing a non-HDR video without using any computer-generated predicted image frames, wherein the HDR video includes a first number of frames per second that is greater than or equal to a second number of frames per second for the non-HDR video.

5. The method of claim 4, wherein the first number of frames per second and the second number of frames per second is 32 frames.

6. The method of claim 1, wherein the computer-generated predicted image frame is generated while the second captured image frame is being captured by the image sensor.

7. The method of claim 1, wherein the one or more processors that are in communication with the image sensor receive a third captured image frame representing the scene in the real-world at a third point in time that is after the second point in time, and the third captured image frame is captured in part while the HDR frame is being generated.

8. The method of claim 1, wherein the computer-generated predicted image frame is a first computer-generated predicted image frame and the HDR frame is a first HDR frame, and the method further comprises:
receiving, at the one or more processors that are in communication with the image sensor, a third captured image frame captured via the image sensor, the third captured image frame representing the scene in the real-world at a third point in time that is after the second point in time; and
in accordance with a determination that the third captured image frame will be used in conjunction with the first captured image frame and the second captured image frame to produce the HDR video:
generating, via the one or more processors and based on the second captured image frame, a second computer-generated predicted image frame representing the scene in the real-world at the time between the second point in time and the third point in time; and
fusing the third image frame with the second computer-generated predicted image frame to generate a second HDR frame for the HDR video.

9. The method of claim 1, further comprising:
receiving, at the one or more processors that are in communication with the image sensor, a third captured image frame captured via the image sensor, the third captured image frame representing the scene in the real-world at a third point in time that is after the second point in time; and
in accordance with a determination that the third captured image frame will be used in conjunction with the first captured image frame and the second captured image frame to produce the HDR video:
generating, via the one or more processors and based on the first captured image frame and the third captured image frame, the computer-generated predicted image frame representing the scene in the real-world at the time between the first point in time and the second point in time; and
fusing the computer-generated predicted image frame with the second image frame and the computer-generated predicted image frame to generate the HDR frame for the HDR video.

10. The method of claim 9, wherein the computer-generated predicted image frame is a first computer-generated predicted image frame and the HDR frame is a first HDR frame, and the method further comprises:
receiving, at the one or more processors that are in communication with the image sensor, a fourth captured image frame captured via the image sensor, the fourth captured image frame representing the scene in the real-world at a fourth point in time that is after the third point in time; and
in accordance with a determination that the fourth captured image frame will be used in conjunction with the first captured image frame, the second captured image frame, and the third captured image frame to produce the HDR video:
generating, via the one or more processors and based on the second captured image frame and the fourth captured image frame, a second computer-generated predicted image frame representing the scene in the real-world at the time between the third point in time and the second point in time; and
fusing the third image frame with the second computer-generated predicted image frame to generate a second HDR frame for the HDR video.

11. The method of claim 1, wherein:
the first captured image frame is a first type of image frame,
the second captured image frame is a second type of image frame, and
the first type of image frame is distinct from the second type of image frame.

12. The method of claim 11, wherein:
the first type of image frame has a short exposure duration; and
the second type of image frame has a long exposure duration that is greater than the short exposure duration.

13. The method of claim 1, wherein the computer-generated predicted image frame is generated via a machine-learning system that has been trained using a training set consisting of a variety of image frames captured by an image sensor viewing different scenes in the real-world.

14. The method of claim 1, wherein the HDR video has a number of frames per second (fps) that is at least equal to a maximum fps achievable by the one or more processors when using captured image frames to produce a video.

15. The method of claim 14, wherein the HDR video has a fps greater than a maximum fps achievable by the one or more processors when using captured image frames to produce a video.

16. The method of claim 1, wherein the image sensor is part of a security camera, smartphone, smart watch, tablet, or AR glasses.

17. A system for generating HDR video, comprising:
an image sensor configured to capture image frames used to produce a high-dynamic range (HDR) video; and
one or more processors that are in communication with the image sensor, the one or more processors configured to:
receive a first captured image frame and a second captured image frame captured via the image sensor, the first captured image frame representing a scene in the real-world at a first point in time and the second captured image frame representing the scene in the real-world at a second point in time that is after the first point in time;
in accordance with a determination that the first captured image frame and the second captured image frame will be used to produce an HDR video:
generate, via the one or more processors and based on the first captured image frame, a computer-generated predicted image frame representing the scene in the real-world at a time between the first point in time and the second point in time; and
fuse the second image frame with the computer-generated predicted image frame to generate an HDR frame for the HDR video.

18. A non-transitory computer-readable storage medium including instructions that, when executed by a device that includes an image sensor, cause the device to:
receive a first captured image frame and a second captured image frame captured via the image sensor, the first captured image frame representing a scene in the real-world at a first point in time and the second captured image frame representing the scene in the real-world at a second point in time that is after the first point in time;
in accordance with a determination that the first captured image frame and the second captured image frame will be used to produce an HDR video:
generate, via the one or more processors and based on the first captured image frame, a computer-generated predicted image frame representing the scene in the real-world at a time between the first point in time and the second point in time; and
fuse the second image frame with the computer-generated predicted image frame to generate an HDR frame for the HDR video.

19. The non-transitory computer-readable storage medium of claim 18, further including instructions that, when executed by the device, cause the device to:
repeat the receiving captured image frames, the generating computer-generated predicted image frames, and the fusing computer-generated predicted image frames with captured image frames to produce respective HDR frames for the HDR video, such that the HDR video has at least 32 frames per second.

20. The non-transitory computer-readable storage medium of claim 18, wherein the HDR video includes:
(i) a first HDR frame that was created by fusing two captured image frames, and
(ii) a second HDR frame that was created by fusing two computer-generated predicted image frames.
